(19) United States
(12) Patent Application Publication
(10) Pub. No.: US 2025/0196605 A1
(43) Pub. Date: Jun. 19, 2025

(54) WHEEL ASSEMBLY AND A VEHICLE INCLUDING THE SAME

(71) Applicants: HYUNDAI MOTOR COMPANY, Seoul (KR); KIA CORPORATION, Seoul (KR)

(72) Inventors: Geun Sang Yu, Hwaseong-si (KR); Joo Young Chun, Hwaseong-si (KR); Jun Hwan Park, Hwaseong-si (KR); Ho Seong Kang, Hwaseong-si (KR); Ji Woo Ha, Hwaseong-si (KR); Ye Sol Kim, Hwaseong-si (KR); Jae Hyuk Choi, Hwaseong-si (KR); Hun Keon Ko, Hwaseong-si (KR)

(73) Assignees: HYUNDAI MOTOR COMPANY, Seoul (KR); KIA CORPORATION, Seoul (KR)

(21) Appl. No.: 18/933,371

(22) Filed: Oct. 31, 2024

(30) Foreign Application Priority Data
Dec. 13, 2023 (KR) 10-2023-0181279

(51) Int. Cl. B60K 1/02; B62D 5/04

(52) U.S. Cl. CPC B60K 1/02; B62D 5/0403; B62D 5/0418

(57) ABSTRACT

A wheel assembly includes a wheel, and a driving module connected to the wheel. In particular, the driving module includes: a first motor defining a first rotation axis extending in an axial direction of the wheel and configured to rotate the wheel about the first rotation axis, a second motor that rotates the wheel about a second rotation axis spaced apart from the first rotation axis in a radial direction of the wheel, and a third motor that provides a driving force for steering the wheel in a third rotation axis that extends in a direction crossing the first rotation axis and the second rotation axis. The second motor is disposed to be spaced apart from the third rotation axis in a first direction that crosses the second rotation axis and the third rotation axis.

### CROSS-REFERENCE TO RELATED APPLICATION

This application claims the benefit of and priority to Korean Patent Application No. 10-2023-0181279, filed in the Korean Intellectual Property Office on Dec. 13, 2023, the entire contents of which are incorporated herein by reference.

### TECHNICAL FIELD

The present disclosure relates to a wheel assembly, and a vehicle including the same.

### BACKGROUND

The statements in this section merely provide background information related to the present disclosure and may not constitute prior art.

As the paradigm shifts from internal combustion engine vehicles to electric vehicles powered by electric motors, and as interest in mobility devices equipped with autonomous driving functions increases, research on mobility devices powered by electric motors is being actively conducted.

The mobility devices may be used in various fields, and for example, the mobility device may be used not only in the field of transporting people, but also in the field of delivering goods.

However, according to a conventional technology, the travel of the mobility device is limited by ground environments on which it operates, which acts as an obstacle in the development of the mobility device.

### SUMMARY

The present disclosure has been made to solve the above-mentioned problems occurring in the prior art while advantages achieved by the prior art are maintained intact.

An aspect of the present disclosure provides a wheel assembly that has various degrees of freedom as compared with the conventional technology and thus has a new structure that may cope with changes in external factors, such as ground environments.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, a wheel assembly includes: a wheel, and a driving module connected to the wheel. In particular, the driving module includes: a first motor defining a first rotation axis extending in an axial direction of the wheel, and the first motor rotates the wheel about the first rotation axis. The driving module further includes: a second motor that rotates the wheel about a second rotation axis spaced apart from the first rotation axis in a radial direction of the wheel, and a third motor that provides a driving force for steering the wheel in a third rotation axis that extends in a direction crossing both the first rotation axis and the second rotation axis. When a direction crossing the second rotation axis and the third rotation axis is referred to as a first direction, the second motor is disposed to be spaced apart from the third rotation axis in the first direction.

Furthermore, the first rotation axis may pass through a center of the wheel, and the first motor may rotate the wheel about the first rotation axis.

Furthermore, the second motor may be disposed to be spaced apart from the second rotation axis in the first direction and may revolve the wheel about the second rotation axis.

Furthermore, the first rotation axis may be revolved about the third rotation axis, and the second rotation axis may be configured such that a relative position thereof to the third rotation axis is fixed.

Furthermore, the third rotation axis may extend in parallel to an upward/downward direction, and the second motor may be disposed on a lower side of an upper end of the third motor.

Furthermore, the first direction may be perpendicular to the second rotation axis and the third rotation axis. When one side of the wheel assembly, in a direction of the third rotation axis, is viewed in a direction being parallel to the third rotation axis, the third rotation axis and a shaft provided in the third motor may cross each other.

Furthermore, the driving module further may include a connection area connecting the wheel and the second motor. In particular, the connection area may include: a revolution area that is revolved about the first rotation axis along a circumferential direction of the wheel; a steering area that defines the third rotation axis and rotates the revolution area about the third rotation axis; and an eccentric area that defines the second rotation axis and connects the steering area and the second motor.

Furthermore, the driving module further may include an eccentric power transmitting part that transmits a driving force of the second motor to the eccentric area. In particular, the second motor may include: an eccentric assistant shaft that is parallel to the second rotation axis and defines an eccentric assistant rotation axis passing through the second motor. The eccentric power transmitting part may connect the eccentric area and the eccentric assistant shaft.

Furthermore, the eccentric power transmitting part may include a first gear connected to the eccentric area, and a second gear connected to the eccentric assistant shaft. The first gear and the second gear may be engaged with each other.

Furthermore, a cross-section of the eccentric power transmitting part taken along the first direction may have a shape of a closed curve surrounding the eccentric area and the eccentric assistant shaft.

Furthermore, each of the eccentric area and the eccentric assistant shaft may have a shape of a sprocket, and the eccentric power transmitting part may have a shape of a chain engaged with the eccentric area and the eccentric assistant shaft.

Furthermore, the eccentric power transmitting part may be provided as a belt, attached to the eccentric area and the eccentric assistant shaft, and formed of a rubber material.

Furthermore, the third motor may include: a steering shaft defining the third rotation axis, and a steering driving part that rotates the steering shaft about the third rotation axis. When one side of the third motor, in a direction of the third rotation axis, is viewed in a direction being parallel to the third rotation axis, the steering shaft may be located inside the steering driving part.

Furthermore, the driving module further may include: a steering power transmitting part that transmits a driving force of the third motor to the steering area. In particular, the third motor may include a steering assistant shaft that crosses the third rotation axis and defines a steering assistant rotation axis passing through the third motor. The steering power transmitting part may be provided as a bevel gear, and the steering power transmitting part may include a ring gear connected to the steering area, and a pinion gear connected to the steering assistant shaft, and engaged with the ring gear.

Furthermore, the driving module further may include a steering power transmitting part that transmits a driving force of the third motor to the steering area. the third motor may include: a steering assistant shaft that is parallel to the third rotation axis and defines a steering assistant rotation axis passing through the third motor. The steering power transmitting part may connect the steering area and the steering assistant shaft.

Furthermore, the steering power transmitting part may be connected to an upper end of the steering area and an upper end of the steering assistant shaft.

Furthermore, a cross-section of the steering power transmitting part in a horizontal direction may have a shape of a closed curve surrounding the steering area and the steering assistant shaft.

Furthermore, each of the steering area and the steering assistant shaft may have a shape of a sprocket, and the steering power transmitting part may have a shape of a chain engaged with the steering area and the steering assistant shaft.

Furthermore, the steering power transmitting part may be provided as a belt attached to the steering area and the steering assistant shaft and formed of a rubber material.

Furthermore, the third rotation axis may extend in parallel to an upward and downward direction (hereinafter “upward/downward direction”) of the body. The steering power transmitting part may include: a first end connected to the steering area to be spaced apart from the third rotation axis in a horizontal direction that is perpendicular to the third rotation axis; a second end connected to the steering assistant shaft to be spaced apart from the steering assistant rotation axis in the horizontal direction; and a link connecting the first end and the second end. The link may be oriented in parallel to a direction, in which the third rotation axis and the steering assistant rotation axis face each other.

Furthermore, the second motor may include: an eccentric assistant shaft that is parallel to the second rotation axis and defines an eccentric assistant rotation axis passing through the second motor, and an eccentric driving part that rotates the eccentric assistant shaft. When one side of the second motor, in a direction of the second rotation axis, is viewed in a direction being parallel to the second rotation axis, the eccentric assistant shaft may be located inside the eccentric driving part.

Furthermore, the first motor may be disposed in an interior of the wheel such that a center thereof crosses the first rotation axis.

Furthermore, the first motor may include: a wheel driving part that provides a driving force for rotating the wheel about the first rotation axis; a driving shaft being parallel to the first rotation axis, defining a wheel driving rotation axis spaced apart from the first rotation axis in a radial direction of the wheel, and provided in the wheel driving part to be rotatable; and a wheel power transmitting part connecting the driving shaft and a central portion of the wheel, through which the first rotation axis passes, and configured to transmit a rotational force of the driving shaft to the wheel, and a cross-section of the wheel power transmitting part in a radial direction of the wheel may have a shape of a closed curve surrounding the central portion of the wheel.

Furthermore, each of the central portion of the wheel and the driving shaft may have a shape of a sprocket, and the wheel power transmitting part has a shape of a chain engaged with the central portion of the wheel and the driving shaft.

Furthermore, the wheel power transmitting part may be provided as a belt attached to the central portion of the wheel and the driving shaft and formed of a rubber material.

According to another aspect of the present disclosure, a vehicle includes a body, and a wheel assembly that causes the body to move and adjust a height of the body with respect to a ground. In particular, the wheel assembly includes a wheel, and a driving module connected to the wheel. In one embodiment, the driving module includes: a first motor defining a first rotation axis extending in an axial direction of the wheel, and that rotates the wheel about the first rotation axis; a second motor that rotates the wheel about a second rotation axis spaced apart from the first rotation axis in a radial direction of the wheel; and a third motor that provides a driving force for steering the wheel in a third rotation axis extending in a direction that crosses both the first rotation axis and the second rotation axis. The second motor may be disposed to be spaced apart from the third rotation axis in a first direction that crosses the second rotation axis and the third rotation axis.

### BRIEF DESCRIPTION OF THE DRAWINGS

The above and other objects, features and advantages of the present disclosure should be more apparent from the following detailed description taken in conjunction with the accompanying drawings:

FIG. 1 is a perspective view of a vehicle according to a first embodiment of the present disclosure;

FIG. 2 is a perspective view of a wheel assembly according to the first embodiment of the present disclosure;

FIG. 3 is a front view of a wheel assembly according to the first embodiment of the present disclosure;

FIG. 4 is a front view schematically illustrating a wheel assembly according to the first embodiment of the present disclosure;

FIG. 5 is a plan view of a wheel assembly according to the first embodiment of the present disclosure;

FIG. 6 is a front view schematically illustrating a wheel assembly according to the first embodiment of the present disclosure;

FIG. 7 is a front view schematically illustrating a wheel assembly according to a modification of the first embodiment of the present disclosure;

FIG. 8 is a plan view schematically illustrating a wheel assembly according to a modification of the first embodiment of the present disclosure;

FIG. 9 is a perspective view of a vehicle according to a second embodiment of the present disclosure;

FIG. 10 is a perspective view of a wheel assembly according to the second embodiment of the present disclosure;

FIG. 11 is a front view of a wheel assembly according to the second embodiment of the present disclosure;

FIG. 12 is a front view schematically illustrating a wheel assembly according to the second embodiment of the present disclosure;

FIG. 13 is a plan view of a wheel assembly according to the second embodiment of the present disclosure;

FIG. 14 is a plan view schematically illustrating a wheel assembly according to the second embodiment of the present disclosure;

FIG. 15 is a perspective view of a vehicle according to a third embodiment of the present disclosure;

FIG. 16 is a perspective view of a wheel assembly according to the third embodiment of the present disclosure;

FIG. 17 is a front view of a wheel assembly according to the third embodiment of the present disclosure;

FIG. 18 is a front view schematically illustrating a wheel assembly according to the third embodiment of the present disclosure;

FIG. 19 is a plan view of a wheel assembly according to the third embodiment of the present disclosure;

FIG. 20 is a plan view schematically illustrating a wheel assembly according to the third embodiment of the present disclosure;

FIG. 21 is a perspective view of a vehicle according to a fourth embodiment of the present disclosure;

FIG. 22 is a perspective view of a wheel assembly according to the fourth embodiment of the present disclosure;

FIG. 23 is a front view of a wheel assembly according to the fourth embodiment of the present disclosure;

FIG. 24 is a front view schematically illustrating a wheel assembly according to the fourth embodiment of the present disclosure;

FIG. 25 is a plan view of a wheel assembly according to the fourth embodiment of the present disclosure;

FIG. 26 is a plan view schematically illustrating a wheel assembly according to the fourth embodiment of the present disclosure;

FIG. 27 is a perspective view of a vehicle according to a fifth embodiment of the present disclosure;

FIG. 28 is a perspective view of a wheel assembly according to the fifth embodiment of the present disclosure;

FIG. 29 is a front view of a wheel assembly according to the fifth embodiment of the present disclosure;

FIG. 30 is a front view schematically illustrating a wheel assembly according to the fifth embodiment of the present disclosure;

FIG. 31 is a plan view of a wheel assembly according to the fifth embodiment of the present disclosure;

FIG. 32 is a plan view schematically illustrating a wheel assembly according to the fifth embodiment of the present disclosure;

FIG. 33 is a perspective view of a vehicle according to a sixth embodiment of the present disclosure;

FIG. 34 is a perspective view of a wheel assembly according to the sixth embodiment of the present disclosure;

FIG. 35 is a front view of a wheel assembly according to the sixth embodiment of the present disclosure;

FIG. 36 is a front view schematically illustrating a wheel assembly according to the sixth embodiment of the present disclosure;

FIG. 37 is a plan view of a wheel assembly according to the sixth embodiment of the present disclosure; and

FIG. 38 is a plan view schematically illustrating a wheel assembly according to the sixth embodiment of the present disclosure.

### DETAILED DESCRIPTION

Hereinafter, embodiments of the present disclosure are described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof have been omitted.

When a component, device, element, or the like of the present disclosure is described as having a purpose or performing an operation, function, or the like, the component, device, or element should be considered herein as being “configured to” meet that purpose or to perform that operation or function.

Hereinafter, a vehicle 1 according to the present disclosure is described with reference to the drawings.

Referring to the drawings, the vehicle 1 may include a wheel assembly 10 and a body 20. A plurality of wheel assemblies 10 may be provided. As an example, four wheel assemblies may be provided. For example, the four wheel assemblies 10 may be coupled to a front left side of the body 20, a front right side of the body 20, a rear left side of the body 20, and a rear right side of the body 20, respectively. The four wheel assemblies may travel together with the body 20, and may raise or lower at least a portion of the body with respect to a ground.

### First Embodiment

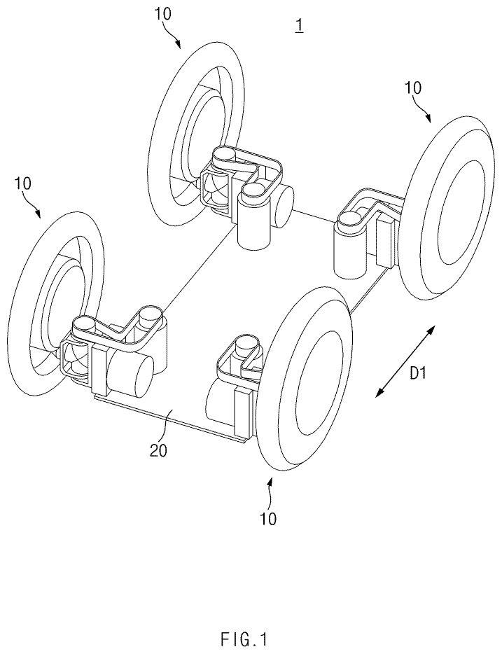

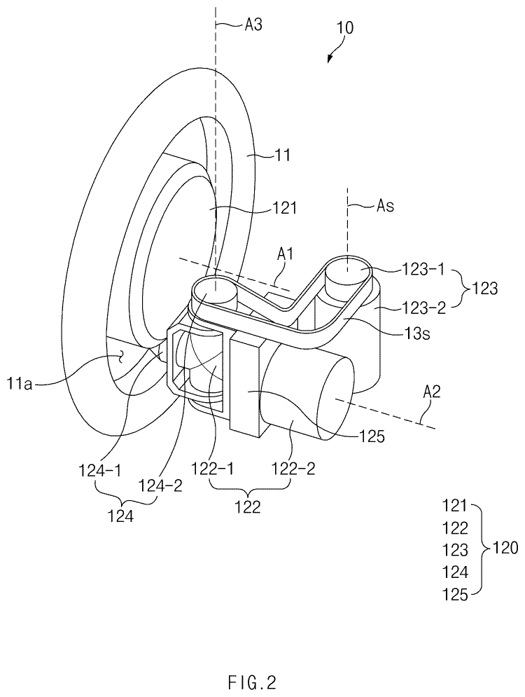

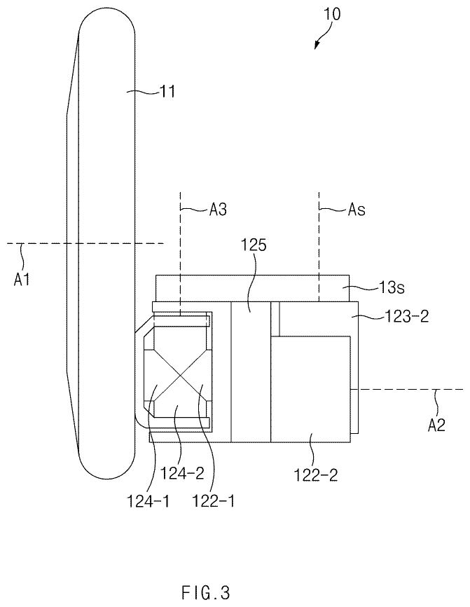

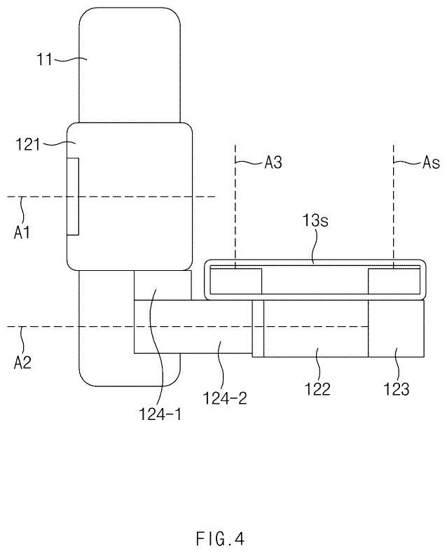

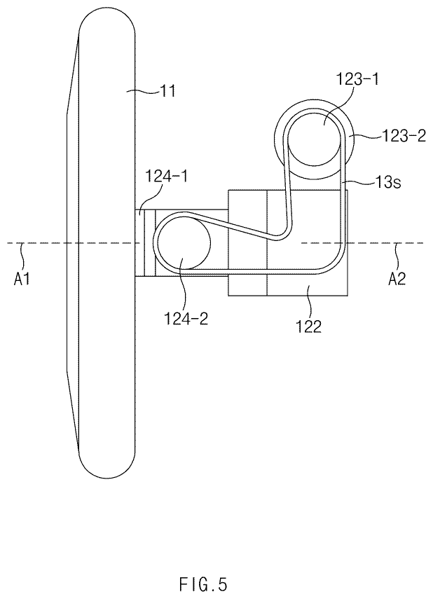

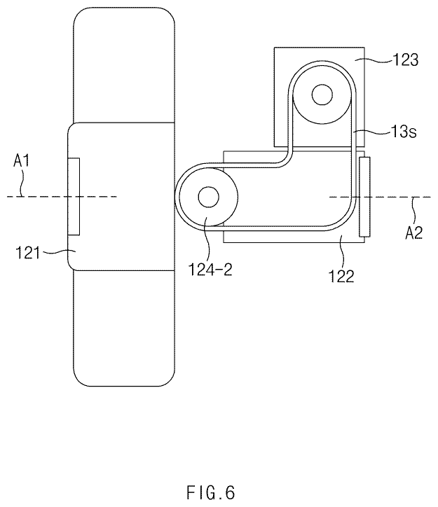

FIG. 1 is a perspective view of a vehicle according to a first embodiment of the present disclosure, and FIG. 2 is a perspective view of the wheel assembly according to the first embodiment of the present disclosure. Furthermore, FIG. 3 is a front view of the wheel assembly according to the first embodiment of the present disclosure, and FIG. 4 is a front view schematically illustrating the wheel assembly according to the first embodiment of the present disclosure. Furthermore, FIG. 5 is a plan view of the wheel assembly according to the first embodiment of the present disclosure, and FIG. 6 is a front view schematically illustrating the wheel assembly according to the first embodiment of the present disclosure.

Referring to FIGS. 1 to 3, a wheel assembly 10 according to the first embodiment of the present disclosure may include a wheel 11, a driving module 120, and a steering power transmitting part 13s. The wheel 11 may be a rotating body that includes a rim and a tire, and makes contact with the ground. In an interior of the wheel 11, a circumferential groove 11a that extends in a circumferential direction of the wheel 11 may be formed. The circumferential groove 11a may have a shape of an annular ring that surrounds a central portion of the wheel 11. As an example, the central portion of the wheel 11 may have a shape that protrudes toward the body 20.

Referring further to FIGS. 3 to 6, the driving module 120 may provide a driving force to the wheel 11. For example, the wheel 11 may be rotated with respect to the body 20 or be moved with respect to the body 20 through the driving module 120. The driving module 120 may include a first motor 121, a second motor 122, a third motor 123, a connection area 124, and a driving body 125.

The first motor 121 may rotate the wheel 11 about the first rotation axis A1. For example, the wheel 11 may be rotated about the first rotation axis A1. The first rotation axis A1 may be defined as an imaginary straight line that passes through a center of the wheel 11 and extends in parallel to an axial direction of the wheel 11. The first motor 121 may be disposed at the central portion of the wheel 11. For example, a center of the first motor 121 and a center of the wheel 11 may be located on the first rotation axis A1. The first motor 121 may include a first shaft and a first driving part.

The first shaft may be an axial member that defines the first rotation axis A1. The first shaft may be named ‘a driving shaft’. A first driving part may rotate the first shaft about the first rotation axis A1. The first driving part may be named ‘a wheel driving part’. The first driving part may include a first stator, a first rotor, and a first housing.

A relative position of the first stator to the first housing may be fixed. Furthermore, the first shaft may be fixed to the first rotor. The first rotor may be rotated about the first rotation axis A1 together with the first shaft with respect to the first stator.

The first housing may define an exterior of the first motor 121 together with the first shaft. The first stator and the first rotor may be accommodated in an interior of the first housing. As an example, the first housing may have a cylindrical shape. Furthermore, the first shaft may have a shape that protrudes from the first housing in a direction that is parallel to a direction of the first rotation axis A1.

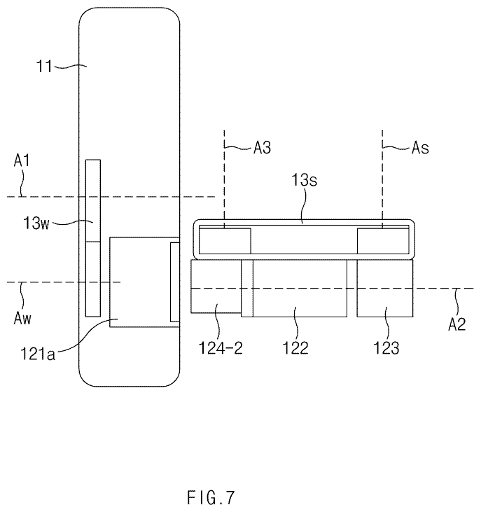

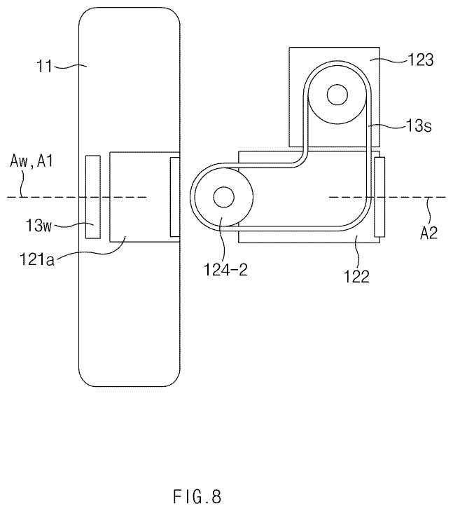

According to a modification of the first embodiment of the present disclosure, the first motor 121a may have a different configuration from the first motor 121 according to the first embodiment. Hereinafter, the first motor 121a and a wheel power transmitting part 13w according to the modification of the first embodiment of the present disclosure are described with reference to FIGS. 7 and 8.

FIG. 7 is a front view schematically illustrating a wheel assembly according to the modification of the first embodiment of the present disclosure. FIG. 8 is a plan view schematically illustrating the wheel assembly according to the modification of the first embodiment of the present disclosure.

Referring to FIG. 7, the first motor 121a may be disposed to be spaced apart from the center of the wheel 11 in the radial direction of the wheel 11. The first motor 121a may define a wheel driving rotation axis Aw. The wheel driving rotation axis Aw may be defined as an imaginary straight line that is parallel to the first rotation axis A1 and is spaced apart from the first rotation axis A1 in the radial direction of the wheel 11. The wheel driving rotation axis Aw may pass through a center of the first motor 121a. For example, the center of the first motor 121a and the center of the wheel 11 may be disposed to be spaced apart from each other in the radial direction of the wheel 11.

Furthermore, the wheel assembly according to the modification of the first embodiment may further include a wheel power transmitting part 13w. The wheel power transmitting part 13w may transmit a rotational force of the first shaft to the wheel 11. For example, the wheel power transmitting part 13w may connect the first shaft and the central portion of the wheel 11.

A cross-section of the wheel power transmitting part 13w, which is taken in the radial direction of the wheel 11, may have a closed curve shape that surrounds the central portion of the wheel 11 and the first shaft. For example, each of the central portion of the wheel 11 and the first shaft may have shape of a sprocket, and the wheel power transmitting part 13w may have shape of a chain that is engaged with the sprocket.

As another example, the wheel power transmitting part 13w may be provided as a belt that is attached to the central portion of the wheel 11 and the first shaft. As a detailed example, the wheel power transmitting part 13w may be formed of a rubber material. As a more detailed example, a rotational force of the first shaft may be sequentially transmitted to the wheel power transmitting part 13w and the central portion of the wheel 11 to rotate the wheel 11, by a frictional force generated between the wheel power transmitting part 13w and the first shaft and a frictional force generated between the wheel power transmitting part 13w and the central portion of the wheel 11.

The contents regarding the shape, disposition relationship, and mutual operations of the first motor 121a, the wheel power transmitting part 13w, and the central portion of the wheel 11 according to the modification of the first embodiment may be applied to a second embodiment, a third embodiment, a fourth embodiment, a fifth embodiment, and a sixth embodiment that are described below.

Referring back to FIGS. 3 to 6, the second motor 122 may rotate the wheel 11 about a second rotation axis A2. For example, the wheel 11 may be revolved about the second rotation axis A2. As a more detailed example, when the wheel 11 is revolved about the second rotation axis A2, the first rotation axis A1 may also be revolved about the second rotation axis A2.

The second rotation axis A2 may be defined as an imaginary straight line that is spaced apart from the first rotation axis A1 in the radial direction of the wheel 11. A position of the second rotation axis A2 with respect to the body 20 may be relatively fixed. Furthermore, when a forward and rearward direction (hereinafter “forward/rearward direction”) of the body 20 is a first direction D1, the second rotation axis A2 may extend in a direction that crosses the first direction D1. For example, the second rotation axis A2 may extend to be perpendicular to the first direction D1 and the upward/downward direction of the body 20. The second motor 122 may include a second shaft 122-1 and a second driving part 122-2.

The second shaft 122-1 may be an axial member that defines the second rotation axis A2. The second shaft 122-1 may be named ‘an eccentric shaft’. The second driving part 122-2 may rotate the second shaft 122-1 about the second rotation axis A2. The second driving part 122-2 may be named ‘an eccentric driving part’. The second driving part 122-2 may include a second stator, a second rotor, and a second housing.

A relative position of the second stator to the second housing may be fixed. Furthermore, the second shaft 122-1 may be fixed to the second rotor. The second rotor may be rotated about the second rotation axis A2 together with the second shaft 122-1 with respect to the second stator.

The second housing may define an exterior of the second motor 122 together with the second shaft 122-1. The second stator and the second rotor may be accommodated in an interior of the second housing. As an example, the second housing may have a cylindrical shape. The second housing may be oriented in parallel to the second rotation axis A2.

For example, when one side of the second motor 122 in the direction of the second rotation axis A2 is viewed in a direction parallel to the second rotation axis A2, the second motor 122 may be oriented so that the second shaft 122-1 is located in the second driving part 122-2 (e.g., the second housing).

The third motor 123 may provide a driving force to the wheel 11 to steer the wheel 11. The third motor 123 may control a traveling direction of the wheel 11 with respect to the body 20. For example, the third motor 123 may rotate the wheel 11 with respect to the body about a third rotation axis A3. The third rotation axis A3 may be defined as an imaginary straight line that extends in a direction that crosses the first rotation axis A1 and the second rotation axis A2. As an example, the third rotation axis A3 may be perpendicular to the first rotation axis A1 and the second rotation axis A2. As an example, the third rotation axis A3 may be defined as an imaginary straight line that extends in the upward/downward direction that is perpendicular to the ground.

A relative position of the second rotation axis A2 to the third rotation axis A3 may be fixed. In other words, regardless of the movement of the wheel 11, the relative positions of the second rotation axis A2 and the third rotation axis A3 to the body 20 may be fixed. Furthermore, the first rotation axis A1 may be configured to be revolved about the third rotation axis A3.

Furthermore, as an example, the third rotation axis A3 may cross the second rotation axis A2 at one point. As an example, a crossing point, at which the third rotation axis A3 and the second rotation axis A2 cross each other, may be located in the connection area 124.

The third motor 123 may be disposed to be spaced apart from the third rotation axis A3 in the first direction D1. Furthermore, the third motor 123 may be disposed to be spaced apart from the third rotation axis A3 on sides in the first direction D1 and the second rotation axis A2. Furthermore, the third motor 123 may be disposed to be spaced apart from the second rotation axis A2 in the first direction D1.

For example, referring back to FIG. 1, the third motor 123 of the wheel assembly 10, which is disposed on the front left side of the body 20, may be spaced rearward and rightward apart from the third rotation axis A3. Furthermore, the third motor 123 of the wheel assembly 10, which is disposed on the front right side of the body 20, may be spaced rearward and leftward apart from the third rotation axis A3.

Furthermore, the third motor 123 of the wheel assembly 10, which is disposed on the rear left side of the body 20, may be spaced forward and rightward apart from the third rotation axis A3. Furthermore, the third motor 123 of the wheel assembly 10, which is disposed on the rear right side of the body 20, may be spaced forward and leftward apart from the third rotation axis A3.

Referring back to FIG. 3, an upper end of the third motor 123 may be disposed on an upper side of the second motor 122. In other words, a height of the upper end of the second motor 122 may be formed to be smaller than a height of the upper end of the third motor 123. For example, a spacing distance between the upper end of the third motor 123 and a lower end of the second motor 122 may be smaller than a radius of the wheel 11. The third motor 123 may include a third shaft 123-1 and a third driving part 123-2.

The third shaft 123-1 may be an axial member that defines a steering assistant rotation axis As. The third shaft 123-1 may be named ‘a steering assistant shaft’. The steering assistant rotation axis As may be defined as an imaginary straight line that extends in a direction that is parallel to the third rotation axis A3 and is spaced apart from the third rotation axis A3. For example, the steering assistant rotation axis As may be spaced apart from the third rotation axis A3 in a direction, in which the first direction A1 and the second rotation axis A2 extend.

The third driving part 123-2 may rotate the third shaft 123-1 about the steering assistant rotation axis As. The third driving part 123-2 may be named ‘a steering driving part’. The third driving part 123-2 may include a third stator, a third rotor, and a third housing.

A relative position of the third stator to the third housing may be fixed. Furthermore, the third shaft 123-1 may be fixed to the third rotor. The third rotor may be rotated about the steering assistant rotation axis As together with the third shaft 123-1 with respect to the third stator.

The third housing may define an exterior of the third motor 123 together with the third shaft 123-1. The third stator and the third rotor may be accommodated in an interior of the third housing. As an example, the third housing may have a cylindrical shape. The third housing may be oriented in parallel to the steering assistant rotation axis As.

For example, when one side of the third motor 123 in the direction of the steering assistant rotation axis As is viewed in a direction that is parallel to the steering assistant rotation axis As, the third motor 123 may be oriented such that the third shaft 123-1 is located in the third driving part 123-2 (e.g., the third housing).

Referring back to FIG. 3, when one side of the wheel assembly in the first direction D1 is viewed in a direction that is parallel to the first direction D1, at least a portion (e.g., a portion of the second housing) of the second motor 122 and at least a portion (e.g., a portion of the third housing that is described below) of the third motor 123 may overlap each other. For example, when one side of the wheel assembly 10 in the first direction D1 is viewed in a direction that is parallel to the first direction D1, the steering assistant rotation axis As may be located in the second housing with respect to the second rotation axis A2. In addition, when one side of the wheel assembly 10 in the first direction D1 is viewed in a direction that is parallel to the first direction D1, the second rotation axis A2 may be located between an upper end and a lower end of the third housing.

The connection area 124 may connect the wheel 11 and the second motor 122. The connection area 124 may include a revolution area 124-1 and a steering area 124-2.

The revolution area 124-1 may be configured to be revolved about the first rotation axis A1 and along the circumferential direction of the wheel 11. The revolution area 124-1 may be accommodated in an interior of the wheel 11. For example, the revolution area 124-1 may be inserted into the circumferential groove 11a.

The revolution area 124-1 may be revolved about the second rotation axis A2 by the second motor 122. The revolution area 124-1 and the second shaft 122-1 may be connected to each other to be rotated in three axes. For example, the revolution area 124-1 and the second shaft 122-1 may be connected to each other by a universal joint. However, the present disclosure is not limited to the example, and the revolution area 124-1 and the second shaft 122-1 may be connected to each other in various ways to be rotated in three axes with respect to each other.

The steering area 124-2 may be aligned with the third rotation axis A3. The steering area 124-2 may rotate the revolution area 124-1 about the third rotation axis A3. For example, the steering area 124-2 may revolve the revolution area 124-1. The steering area 124-2 may be connected to the second motor 122 (e.g., the second shaft 122-1) to be rotatable. For example, the steering area 124-2 may be rotated about the third rotation axis A3 with respect to the second motor 122. As a more detailed example, the steering area 124-2 may be connected to the driving body 125 fixed to the second motor 122 to be rotated about the third rotation axis A3.

The steering area 124-2 may receive a driving force from the third motor 123. For example, the steering area 124-2 may receive the driving force generated by the third shaft 123-1 through the steering power transmitting part 13s that is described below.

Referring back to FIG. 2, the driving body 125 may support the second motor 122. For example, the driving body 125 may connect the second motor 122 and the body 20. The driving body 125 may define at least a portion of an exterior of the driving module 120.

The steering power transmitting part 13s may connect the steering area 124-2 and the third shaft 123-1. The steering power transmitting part 13s may be connected to an upper end of the steering area 124-2 and an upper end of the third shaft 123-1.

The steering power transmitting part 13s may receive the driving force from the third shaft 123-1, and may transmit the received driving force to the steering area 124-2. A cross-section of the steering power transmitting part 13s in the horizontal direction may have a closed curve shape that surrounds the steering area 124-2 and the third shaft 123-1. The horizontal direction may refer to a direction that is perpendicular to the upward/downward direction.

For example, each of the steering area 124-2 and the third shaft 123-1 may have a shape of a sprocket, and the steering power transmitting part 13s may have a shape of a chain that is engaged with the steering area 124-2 and the third shaft 123-1.

As another example, the steering power transmitting part 13s may be provided as a belt that is attached to the steering area 124-2 and the third shaft 123-1. As a detailed example, the steering power transmitting part 13s may be formed of a rubber material. As a more detailed example, due to a frictional force generated between the steering power transmitting part 13s and the steering area 124-2 and a frictional force generated between the steering power transmitting part 13s and the third shaft 123-1, a rotational force of the third shaft 123-1 may be sequentially transmitted to the steering power transmitting part 13s and the steering area 124-2, and thus, the steering area 124-2 may be rotated about the third rotation axis A3.

### Second Embodiment

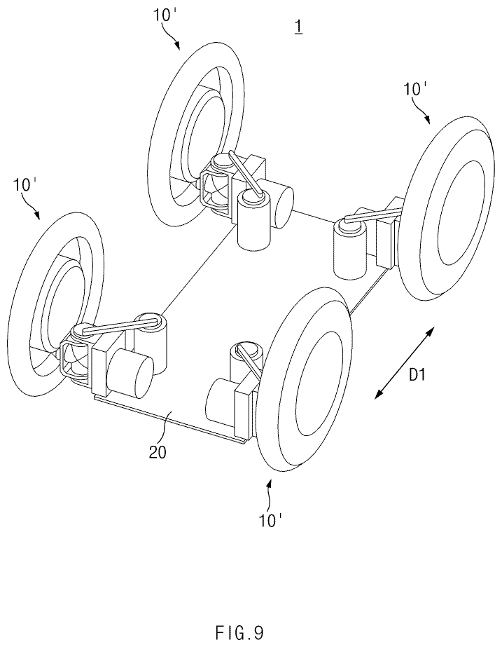

Hereinafter, with reference to FIGS. 9 to 14, a wheel assembly 10′ according to a second embodiment of the present disclosure is described. In a description of the wheel assembly 10′ according to the second embodiment of the present disclosure, differences from the first embodiment of the present disclosure are mainly described.

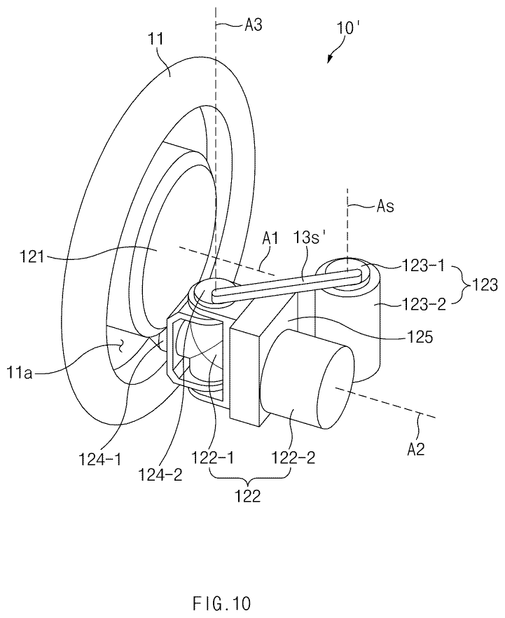

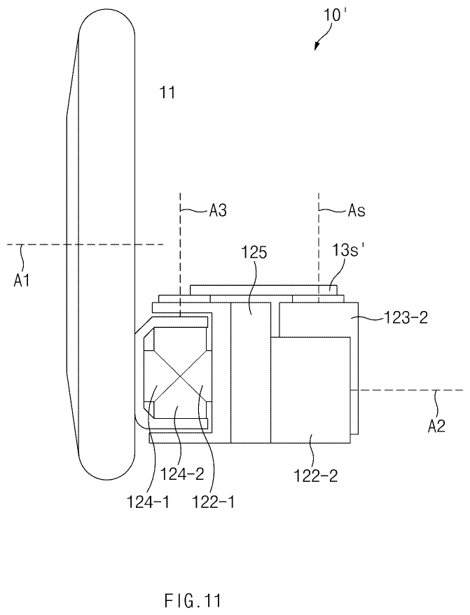

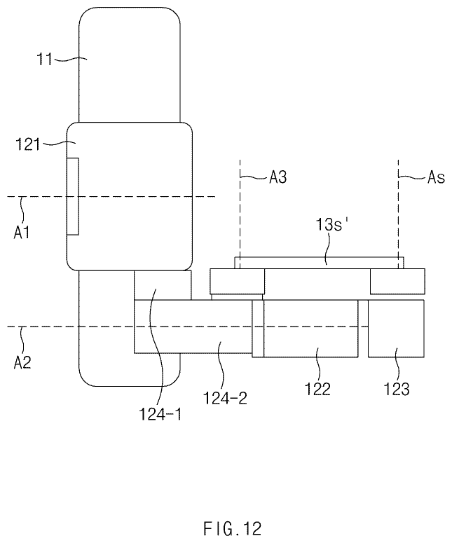

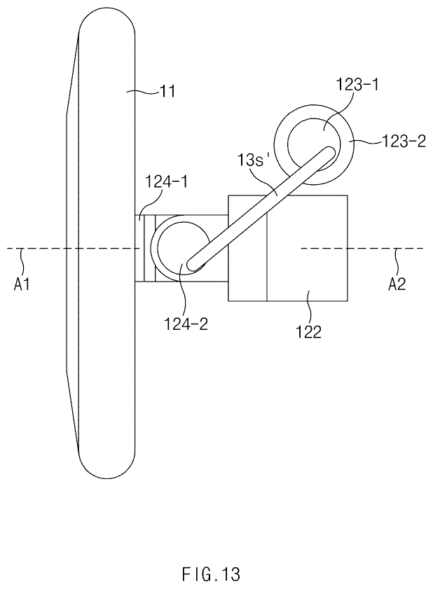

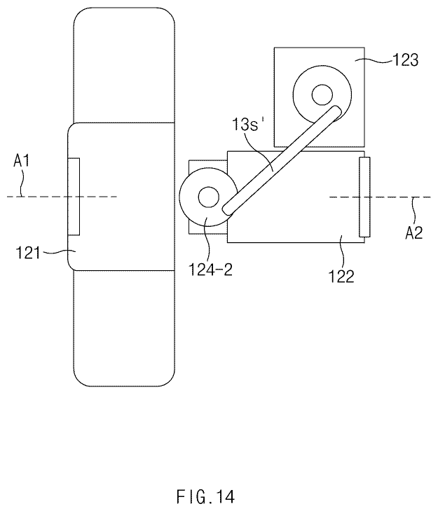

FIG. 9 is a perspective view of a vehicle according to a second embodiment of the present disclosure, and FIG. 10 is a perspective view of a wheel assembly according to the second embodiment of the present disclosure. Furthermore, FIG. 11 is a front view of the wheel assembly according to the second embodiment of the present disclosure, and FIG. 12 is a front view schematically illustrating the wheel assembly according to the second embodiment of the present disclosure. Furthermore, FIG. 13 is a plan view of the wheel assembly according to the second embodiment of the present disclosure, and FIG. 14 is a plan view schematically illustrating the wheel assembly according to the second embodiment of the present disclosure.

Referring to FIG. 10, the wheel assembly 10′ according to the second embodiment of the present disclosure may include a wheel 11, a driving module 120, and a steering power transmitting part 13s′. For a description of the wheel 11 according to the second embodiment, the description of the wheel 11 according to the first embodiment is used.

Furthermore, the driving module 120 according to the second embodiment may include a first motor 121, a second motor 122, a third motor 123, a connection area 124, and a driving body 125. The first motor 121 may include a first shaft and a first driving part. The first driving part may include a first stator, a first rotor, and a first housing. For a description of the first shaft, the first stator, the first rotor, and the first housing according to the second embodiment, the description of the first shaft, the first stator, the first rotor, and the first housing according to the first embodiment is used.

The second motor 122 may include a second shaft 122-1 and a second driving part 122-2. The second driving part 122-2 may include a second stator, a second rotor, and a second housing. For the description of the second shaft 122-1, the second stator, the second rotor, and the second housing according to the second embodiment, the description of the second shaft 122-1, the second stator, the second rotor, and the second housing according to the first embodiment is used.

The third motor 123 may include a third shaft 123-1 and a third driving part 123-2. The third driving part 123-2 may include a third stator, a third rotor, and a third housing. For a description of the third shaft 123-1, the third stator, the third rotor, and the third housing according to the second embodiment, the description of the third shaft 123-1, the third stator, the third rotor, and the third housing according to the first embodiment is applied.

The connection area 124 may include a revolution area 124-1 and a steering area 124-2. For a description of the revolution area 124-1 and the steering area 124-2 according to the second embodiment, the description of the revolution area 124-1 and the steering area 124-2 according to the first embodiment is applied.

For the description of the driving body 125 according to the second embodiment, the description of the driving body 125 according to the first embodiment is applied.

Referring to FIGS. 11 to 14, a steering power transmitting part 13s′ may include a first end, a second end, and a link. The first end may define one end of the steering power transmitting part 13s′. The first end may be connected to an upper end of the steering area 124-2. Furthermore, the first end may be spaced apart from the third rotation axis A3 in the horizontal direction.

For example, the first end may be connected to an upper end of the steering area 124-2 to be rotated about the first link rotation axis. The first link rotation axis may be defined as an imaginary straight line that passes through the first end and is parallel to the third rotation axis A3. The first end may be disposed to be revolved about the third rotation axis A3 when the steering area 124-2 is rotated about the third rotation axis A3.

The second end may refer to an opposite end of the steering power transmitting part 13s′. The second end may be connected to an upper end of the third shaft 123-1. The second end may be spaced apart from the steering assistant rotation axis As in the horizontal direction.

For example, the second end may be connected to an upper end of the third shaft 123-1 to be rotated about the second link rotation axis. The second link rotation axis may be defined as an imaginary straight line that passes through the second end and is parallel to the steering assistant rotation axis As. The second end may be revolved about the steering assistant rotation axis As when the third shaft 123-1 is rotated about the steering assistant rotation axis As.

The link may connect the first end and the second end. The link may be integrally formed with the first end and the second end. The link may be oriented in parallel to a direction, in which the third rotation axis A3 and the steering assistant axis face each other. For example, when the first end and the second end are revolved about the steering area 124-2 and the third shaft 123-1, respectively, a direction, in which the link is oriented, may be maintained constant.

Through the orientation structure of the link, rotation angles of the third shaft 123-1 and the steering area 124-2 may be formed to be the same when the driving force of the third shaft 123-1 is transmitted to the steering area 124-2.

### Third Embodiment

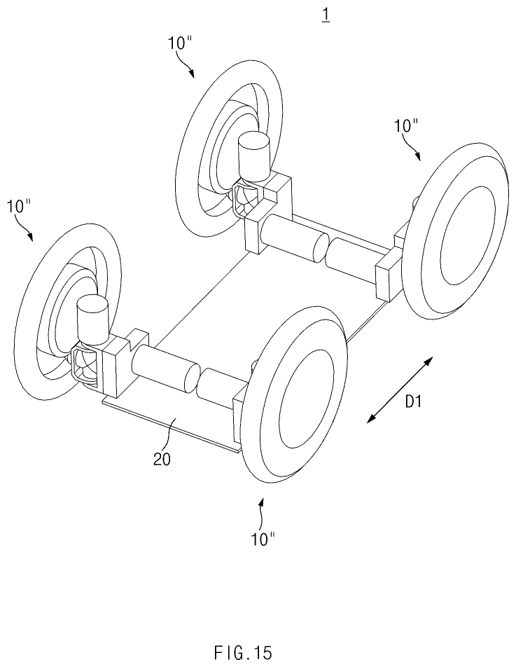

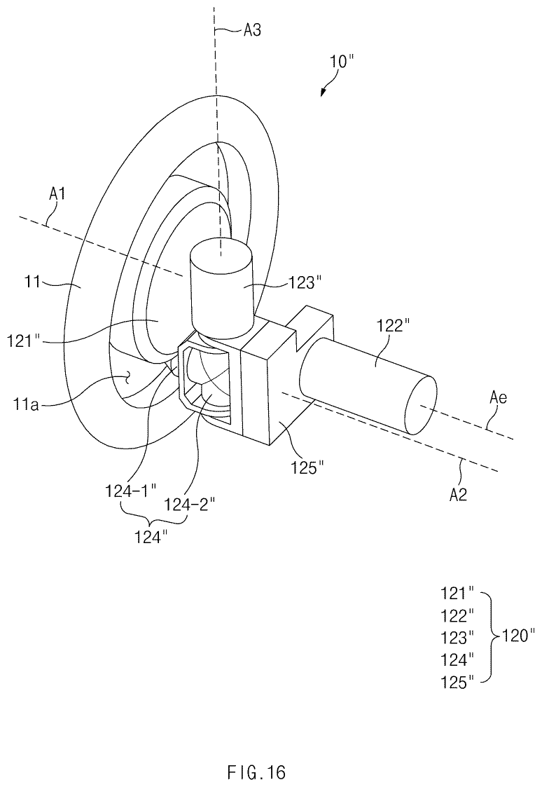

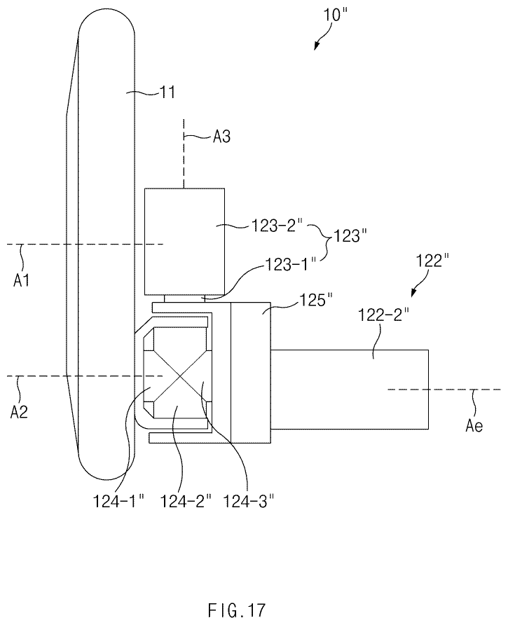

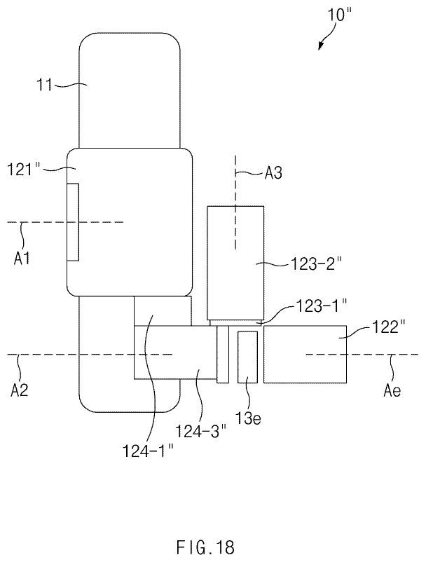

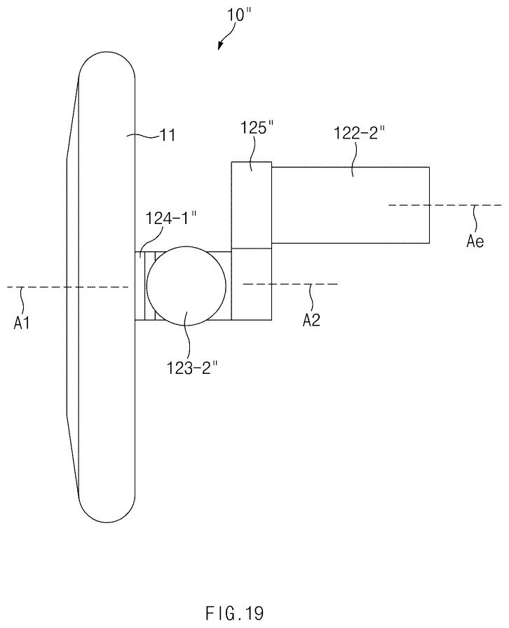

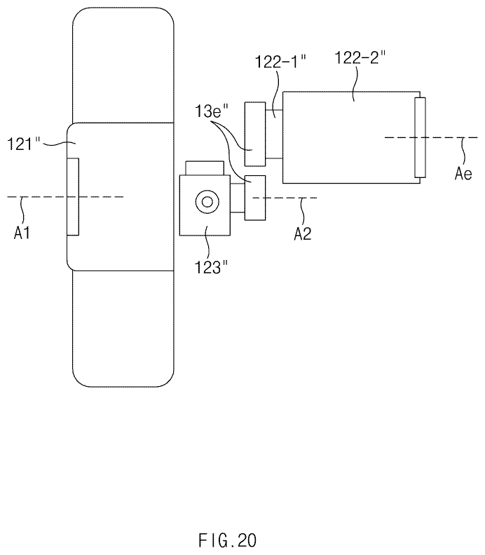

FIG. 15 is a perspective view of a vehicle according to a third embodiment of the present disclosure, and FIG. 16 is a perspective view of a wheel assembly according to the third embodiment of the present disclosure. FIG. 17 is a front view of the wheel assembly according to the third embodiment of the present disclosure, and FIG. 18 is a front view schematically illustrating the wheel assembly according to the third embodiment of the present disclosure. FIG. 19 is a plan view of the wheel assembly according to the third embodiment of the present disclosure, and FIG. 20 is a plan view schematically illustrating the wheel assembly according to the third embodiment of the present disclosure.

Referring to FIGS. 15 and 16, a wheel assembly 10″ according to the third embodiment of the present disclosure may include a wheel 11, a driving module 120″, and an eccentric power transmitting part 13e″. The wheel 11 may be a rotating body that includes a rim and a tire, and is configured to make contact with the ground. In an interior of the wheel 11, a circumferential groove 11a that extends in a circumferential direction of the wheel 11 may be formed. The circumferential groove 11a may have an annular ring shape that surrounds a central portion of the wheel 11. As an example, the central portion of the wheel 11 may have a shape that protrudes toward the body 20.

Referring further to FIGS. 17 to 20, the driving module 120″ may provide a driving force to the wheel 11. For example, the wheel 11 may be rotated with respect to the body 20 or be moved with respect to the body 20 through the driving module 120″. The driving module 120″ may include a first motor 121″, a second motor 122″, a third motor 123″, a connection area 124″, and a driving body 125″.

The first motor 121″ may rotate the wheel 11 about the first rotation axis A1. For example, the wheel 11 may be rotated about a first rotation axis A1. The first rotation axis A1 may be defined as an imaginary straight line that passes through the center of the wheel 11 and extends in parallel to the axial direction of the wheel 11. The first motor 121″ may be disposed at the central portion of the wheel 11. For example, a center of the first motor 121″ and a center of the wheel 11 may be located on the first rotation axis A1. The first motor 121″ may include a first shaft and a first driving part.

The first shaft may be an axial member that define a first rotation axis A1. The first shaft may be named ‘a driving shaft’. The first driving part may rotate the first shaft about the first rotation axis A1. The first driving part may be named ‘a wheel driving part’. The first driving part may include a first stator, a first rotor, and a first housing.

A relative position of the first stator to the first housing may be fixed. Furthermore, the first shaft may be fixed to the first rotor. The first rotor may be rotated about the first rotation axis A1 together with the first shaft with respect to the first stator.

The first housing may define an exterior of the first motor 121″ together with the first shaft. The first stator and the first rotor may be accommodated inside the first housing. As an example, the first housing may have a cylindrical shape. Furthermore, the first shaft may have a shape that protrudes from the first housing in a direction that is parallel to the first rotation axis A1.

The second motor 122″ may rotate the wheel 11 about the second rotation axis A2. For example, the wheel 11 may be revolved about a second rotation axis A2. As a more detailed example, when the wheel 11 is rotated about the second rotation axis A2, the first rotation axis A1 may also be rotated about the second rotation axis A2.

The second rotation axis A2 may be defined as an imaginary straight line that is spaced apart from the first rotation axis A1 in the radial direction of the wheel 11. A position of the second rotation axis A2 with respect to the body 20 may be relatively fixed. Furthermore, when a forward/rearward direction of the body 20 is the first direction D1, the second rotation axis A2 may extend in a direction that crosses the first direction D1. For example, the second rotation axis A2 may extend to be perpendicular to the first direction D1 and the upward/downward direction.

The second motor 122″ may be disposed to be spaced apart from the third rotation axis A3 in the first direction D1. Moreover, the second motor 122″ may be disposed to be spaced apart from the third rotation axis A3 to one side in the first direction D1 and the second rotation axis A2. Furthermore, the second motor 122″ may be disposed to be spaced apart from the second rotation axis A2 in the first direction D1.

For example, referring back to FIG. 15, the second motor 122″ of the wheel assembly 10″, which is disposed on a front left side of the body 20, may be disposed to be spaced rearward and rightward apart from the third rotation axis A3. Furthermore, the second motor 122″ of the wheel assembly 10″, which is disposed on a front right side of the body 20, may be disposed to be spaced rearward and leftward apart from the third rotation axis A3.

Furthermore, the second motor 122″ of the wheel assembly 10″, which is disposed on a rear left side of the body 20, may be disposed to be spaced forward and rightward apart from the third rotation axis A3. Furthermore, the second motor 122″ of the wheel assembly 10″, which is disposed on a rear right side of the body 20, may be disposed to be spaced forward and leftward apart from the third rotation axis A3. The second motor 122″ may be disposed on a lower side of the third motor 123″. The second motor 122″ may include a second shaft 122-1″ and a second driving part 122-2″.

The second shaft 122-1″ may be an axial member that defines an eccentric assistant rotation axis Ae. The second shaft 122-1″ may be named ‘an eccentric auxiliary shaft’. The eccentric assistant rotation axis Ae may be defined as an imaginary straight line that extends in a direction that is parallel to the second rotation axis A2 and is spaced apart from the second rotation axis A2 in the first direction D1. As an example, the eccentric assistant rotation axis Ae may extend in the leftward/rightward direction. Furthermore, the eccentric assistant rotation axis Ae may be spaced apart from the second rotation axis A2 in a direction, in which the first direction D1 and the second rotation axis A2 extend.

The second driving part 122-2″ may rotate the second shaft 122-1″ about the eccentric assistant rotation axis Ae. The second driving part 122-2″ may be named ‘an eccentric driving part’. The second driving part 122-2″ may include a second stator, a second rotor, and a second housing.

A relative position of the second stator to the second housing may be fixed. Furthermore, the second shaft 122-1″ may be fixed to the second rotor. The second rotor may be rotated about the eccentric assistant rotation axis Ae together with the second shaft 122-1″ with respect to the second stator.

The second housing may define an exterior of the second motor 122″ together with the second shaft 122-1″. The second stator and the second rotor may be accommodated in an interior of the second housing. As an example, the second housing may have a cylindrical shape. The second housing may be oriented in parallel to the eccentric assistant rotation axis Ae.

For example, when one side of the second motor 122″ in the direction of the eccentric assistant rotation axis Ae is viewed in a direction that is parallel to the eccentric assistant rotation axis Ae, the second motor 122″ may be oriented such that the second shaft 122-1″ is located in the second driving part 122-2″ (e.g., the second housing).

Referring again to FIG. 17, when one side of the wheel assembly 10″ in the first direction D1 is viewed in a direction that is parallel to the first direction D1, the second housing and the third motor 123″ may not overlap each other. For example, when one side of the wheel assembly 10″ in the first direction D1 is viewed in a direction that is parallel to the first direction D1, the eccentric assistant rotation axis Ae and the third motor 123″ may be disposed to be spaced apart from each other in upward/downward direction. In addition, when one side of the wheel assembly 10″ in the first direction D1 is viewed in a direction that is parallel to the first direction D1, the third rotation axis A3 may be disposed to be spaced apart from the second housing in the leftward/rightward direction.

The third motor 123″ may provide a driving force to the wheel 11 to steer the wheel 11. The third motor 123″ may adjust a traveling direction of the wheel 11 with respect to the body 20. For example, the third motor 123″ may revolve the wheel 11 with respect to the body 20 about the third rotation axis A3. The third rotation axis A3 may be defined as an imaginary straight line that extends in a direction that crosses the first rotation axis A1 and the second rotation axis A2. As an example, the third rotation axis A3 may be perpendicular to the first rotation axis A1 and the second rotation axis A2. As an example, the third rotation axis A3 may be defined as an imaginary straight line that extends in the upward/downward direction that is perpendicular to the ground.

A relative position of the second rotation axis A2 to the third rotation axis A3 may be fixed. In other words, regardless of the movement of the wheel 11, the relative positions of the second rotation axis A2 and the third rotation axis A3 to the body 20 may be fixed. Furthermore, the first rotation axis A1 may be configured to be revolved about the third rotation axis A3.

Furthermore, as an example, the third rotation axis A3 may cross the second rotation axis A2 at one point. As an example, a crossing point, at which the third rotation axis A3 and the second rotation axis A2 cross each other may be located in a connection area 124″. The third motor 123″ may include a third shaft 123-1″ and a third driving part 123-2″.

The third shaft 123-1″ may be an axial member that defines the third rotation axis A3. In other words, the third motor 123″ according to the third embodiment of the present disclosure may not be spaced apart from the third rotation axis A3, unlike the third motor 123 according to the first embodiment. For example, when one side of the wheel assembly 10″ in the direction of the third rotation axis A3 is viewed in a direction that is parallel to the third rotation axis A3, the third rotation axis A3 and the third shaft 123-1″ provided in the third motor 123″ may cross each other. The third driving part 123-1″ may be named as ‘a steering shaft’.

The third driving part 123-2″ may rotate the third shaft 123-1″ about the third rotation axis A3. The third driving part 123-2″ may be named ‘steering driving part’. The third driving part 123-2″ may include a third stator, a third rotor, and a third housing.

A relative position of the third stator to the third housing may be fixed. Furthermore, the third shaft 123-1″ may be fixed to the third rotor. The third rotor may be rotated about a third rotation axis A3 together with the third shaft 123-1″ with respect to the third stator.

The third housing may define an exterior of the third motor 123″ together with the third shaft 123-1″. The third stator and the third rotor may be accommodated inside the third housing. As an example, the third housing may have a cylindrical shape. The third housing may be oriented in parallel to the third rotation axis A3.

For example, when one side of the third motor 123″ in the direction of the third rotation axis A3 is viewed in a direction that is parallel to the third rotation axis A3, the third motor 123″ may be oriented such that the third shaft 123-1″ is located in the third driving part 123-2″ (e.g., a third housing).

The connection area 124″ may connect the wheel 11 and the second motor 122. The connection area 124″ may include a revolution area 124-1″, a steering area 124-2″, and an eccentric area 124-3″.

The revolution area 124-1″ may be configured to be revolved about the first rotation axis A1 along the circumferential direction of the wheel 11. The revolution area 124-1″ may be accommodated in an interior of the wheel 11. For example, the revolution area 124-1″ may be inserted into the circumferential groove 11a.

The revolution area 124-1″ may receive a driving force from the eccentric area 124-3″ and may be revolved about the second rotation axis A2. The revolution area 124-1″ and the eccentric area 124-3″ may be connected to each other to be rotated in three axes with respect to each other. For example, the revolution area 124-1″ and the eccentric area 124-3″ may be connected to each other by using a universal joint. However, the present disclosure is not limited to the example, and the revolution area 124-1″ and the eccentric area 124-3″ may be connected to each other in various ways to be rotated in three axes with respect to each other.

The steering area 124-2 may rotate the revolution area 124-1 about the third rotation axis A3. For example, the steering area 124-2 may receive a driving force from the third motor 123″ and may revolve the revolution area 124-1.

The steering area 124-2″ may be connected to the third motor 123″ in the upward/downward direction. For example, the steering area 124-2″ may be connected to a lower end of the third shaft 123-1″.

The steering area 124-2 may be connected to the eccentric area 124-3″ to be rotatable. For example, the steering area 124-2 may be rotatable about the third rotation axis A3 with respect to the eccentric area 124-3″.

The eccentric area 124-3″ may define the second rotation axis A2. The eccentric area 124-3″ may connect the steering area 124-2″ and the second motor 122″. For example, the eccentric area 124-3″ may receive a driving force from the second motor 122″. As a detailed example, the driving force generated by the second motor 122″ may be sequentially transmitted to the second shaft 122-1″, the eccentric power transmitting part 13e″, and the eccentric area 124-3″.

The eccentric area 124-3″ may rotate the revolution area 124-1″ about the second rotation axis A2 with the driving force transmitted from the eccentric power transmitting part 13e″.

The eccentric power transmitting part 13e″ may transmit the driving force generated by the second motor 122″ to the eccentric area 124-3″. The eccentric power transmitting part 13e″ may connect the second shaft 122-1″ and the eccentric area 124-3″.

For example, referring to FIG. 20, the eccentric power transmitting part 13e″ may include two gears that are connected to the eccentric area 124-3″ and the second shaft 122-1″, respectively, and are engaged with each other. The gear connected to the eccentric area 124-3″ may be named a first gear, and the gear connected to the second shaft 122-1″ may be named a second gear. The first gear may be connected to an outer peripheral surface of the eccentric area 124-3″, and the second gear may be connected to an outer peripheral surface of the second shaft 122-1″. The first gear and the second gear may be engaged with each other. For example, the second gear may be rotated about the eccentric assistant rotation axis Ae through rotation of the second shaft 122-1″, and the first gear engaged with the second gear may be rotated about the second rotation axis A2 through rotation of the second gear.

As another example, a cross-section of the eccentric power transmitting part 13e″ taken in the first direction D1 may have a shape of a closed curve that surrounds the eccentric area 124-3″ and the second shaft 122-1″. As a detailed example, each of the eccentric area 124-3″ and the second shaft 122-1″ may have a shape of a sprocket, and the eccentric power transmitting part 13e″ may have a shape of a chain that is engaged with the eccentric area 124-3″ and the second shaft 122-1″.

As another example, the eccentric power transmitting part 13e″ may be provided as a belt that is attached to the eccentric area 124-3″ and the second shaft 122-1″. As a detailed example, the eccentric power transmitting part 13e″ may be formed of a rubber material. As a more detailed example, due to the frictional force generated between the eccentric power transmitting part 13e″ and the eccentric area 124-3″, and the frictional force generated between the eccentric power transmitting part 13e″ and the second shaft 122-1″, a rotational force of the second shaft 122-1″ may be sequentially transmitted to the eccentric power transmitting part 13e″ and the eccentric area 124-3″ and the wheel 11 may be revolved about the second rotation axis A2.

### Fourth Embodiment

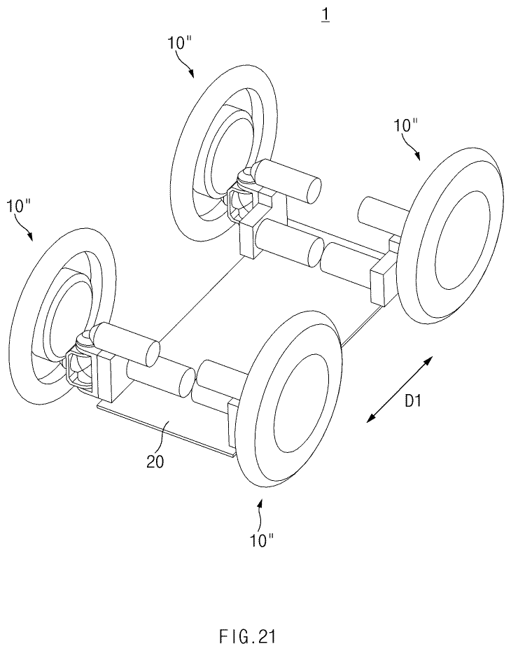

Hereinafter, a wheel assembly 10′″ according to a fourth embodiment of the present disclosure is described with reference to FIGS. 21 to 26. In a description of the wheel assembly 10′″ according to the fourth embodiment of the present disclosure, differences from the third embodiment of the present disclosure are mainly described.

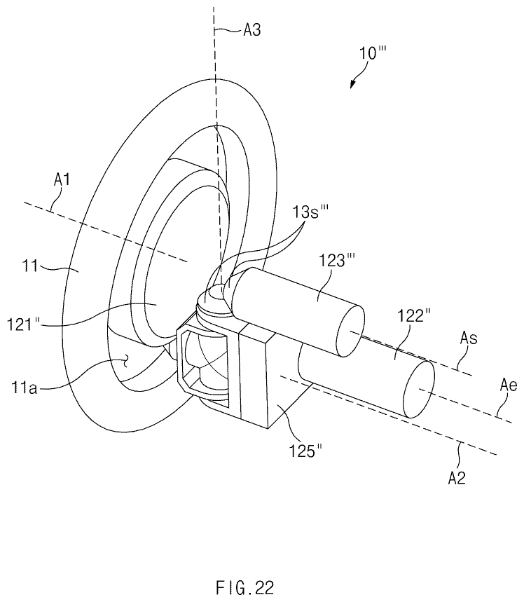

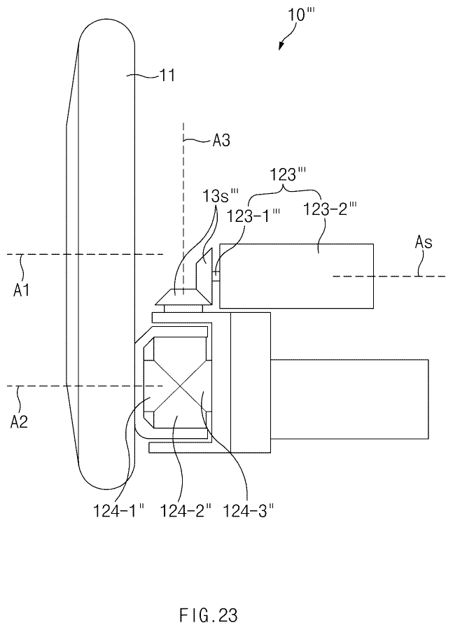

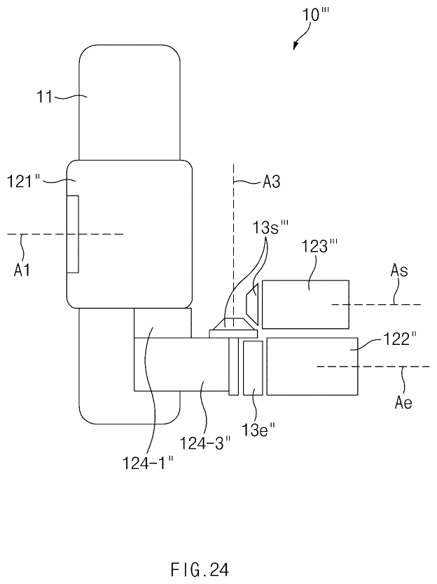

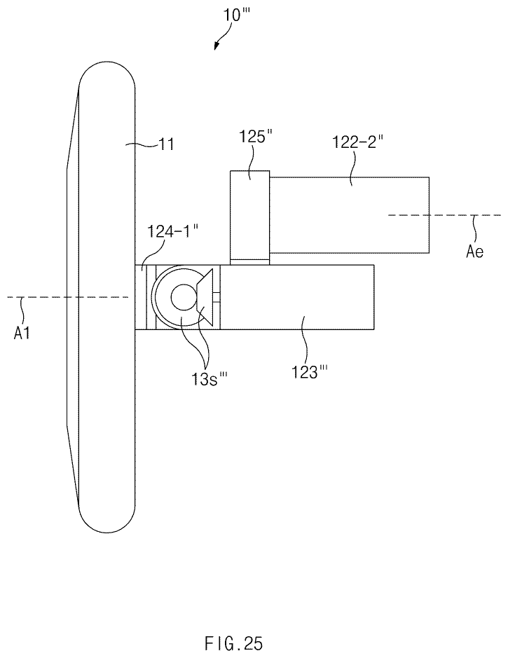

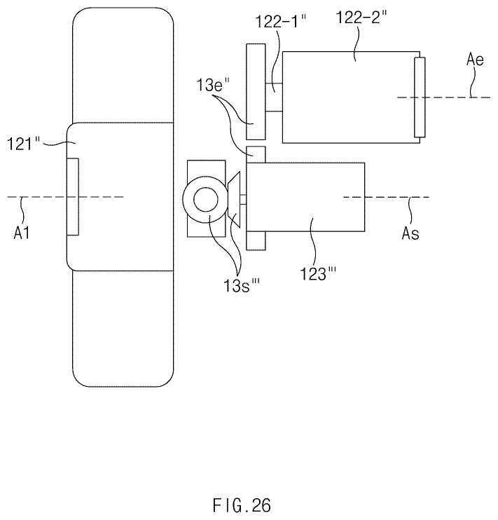

FIG. 21 is a perspective view of a vehicle according to the fourth embodiment of the present disclosure, and FIG. 22 is a perspective view of a wheel assembly according to the fourth embodiment of the present disclosure. Furthermore, FIG. 23 is a front view of the wheel assembly according to the fourth embodiment of the present disclosure. FIG. 24 is a front view schematically illustrating the wheel assembly according to the fourth embodiment of the present disclosure. FIG. 25 is a plan view of the wheel assembly according to the fourth embodiment of the present disclosure, and FIG. 26 is a plan view schematically illustrating the wheel assembly according to the fourth embodiment of the present disclosure.

Referring to FIGS. 21 and 22, a wheel assembly 10′″ according to the fourth embodiment of the present disclosure includes a wheel 11, driving modules 121″, 122″, 123′″, 124″, and 125″, an eccentric power transmitting part 13e″, and a steering power transmitting part 13s′″. For a description of the wheel 11 according to the fourth embodiment, the description of the wheel 11 according to the third embodiment is used.

In addition, the driving modules 121″, 122″, 123′″, 124″, and 125″ according to the fourth embodiment include a first motor 121″, a second motor 122″, a third motor 123′″, a connection area 124″, and a driving body 125″. The first motor 121″ may include a first shaft and a first driving part. The first driving part may include a first stator, a first rotor, and a first housing. For a description of the first shaft, the first stator, the first rotor, and the first housing according to the fourth embodiment, the description of the first shaft, the first stator, the first rotor, and the first housing according to the third embodiment is used.

The second motor 122″ may include a second shaft 122-1″ and a second driving part 122-2″. The second driving part 122-2″ may include a second stator, a second rotor, and a second housing. For a description of the second shaft 122-1″, the second stator, the second rotor, and the second housing according to the fourth embodiment, the description of the second shaft 122-1″, the second stator, the second rotor, and the second housing according to the third embodiment is applied.

Referring to FIGS. 23 to 26, the third motor 123′″ according to the fourth embodiment may provide a driving force to the steering area 124-2″. The third motor 123′″ may rotate the steering area 124-2″ about the third rotation axis A3. The third motor 123′″ may include a third shaft 123-1′″ and a third driving part 123-2′″.

The third shaft 123-1′″ may be an axial member that defines the steering assistant rotation axis As. The third shaft 123-1′″ may be named ‘a steering assistant shaft’. The steering assistant rotation axis As may be defined as an imaginary straight line that extends in a direction that is parallel to the second rotation axis A2, and is spaced apart from the second rotation axis A2 in the upward/downward direction. The steering assistant rotation axis As may be disposed on an upper side of the second rotation axis A2. Furthermore, the steering assistant rotation axis As may cross the third rotation axis A3 at one point. A crossing point of the steering assistant rotation axis As and the third rotation axis A3 may be located on an outside of the driving module 120″. In other words, the crossing point of the steering assistant rotation axis As and the third rotation axis A3 may be formed not to meet the driving module 120″.

The third driving part 123-2′″ may rotate the third shaft 123-1′″ about the steering assistant rotation axis As. The third driving part 123-2′″ may be named ‘a steering driving part’. The third driving part 123-2′″ may include a third stator, a third rotor, and a third housing.

A relative position of the third stator to the third housing may be fixed. Furthermore, the third shaft 123-1′″ may be fixed to the third rotor. The third rotor may be rotated about the eccentric assistant rotation axis Ae together with the third shaft 122-1′″ with respect to the third stator.

The third housing may define an exterior of the third motor 123′″ together with the third shaft 123-1′″. The third stator and the third rotor may be accommodated in an interior of the third housing. As an example, the third housing may have a cylindrical shape. The third housing may be oriented in parallel to the steering assistant rotation axis As.

For example, when one side of the third motor 123′″ in the direction of the steering assistant rotation axis As is viewed in a direction that is parallel to the steering assistant rotation axis As, the third motor 123′″ may be oriented such that the third shaft 123-1′″ is located in the third driving part 123-2′″ (e.g., the third housing).

The connection area 124″ according to the fourth embodiment may include a revolution area 124-1″, a steering area 124-2″, and an eccentric area 124-3″. For a description of the revolution area 124-1″, the steering area 124-2″, and the eccentric area 124-3″ according to the fourth embodiment, the description of the revolution area 124-1″, the steering area 124-2″, and the eccentric area 124-3″ according to the third embodiment is used.

For a description of the driving body 125″ according to the fourth embodiment, the description of the driving body 125″ according to the third embodiment is used.

For a description of the eccentric power transmitting part 13e″ according to the fourth embodiment, the description of the eccentric power transmitting part 13e″ according to the third embodiment is used.

Referring to FIGS. 22 and 23, the steering power transmitting part 13s′″ according to the fourth embodiment may be provided as a bevel gear. The steering power transmitting part 13s′″ may include a ring gear that is connected to the steering area 124-2″, and a pinion gear that is connected to the third shaft 123-1′″.

The ring gear may be connected to an upper portion of the steering area 124-2″. The ring gear may be engaged with a pinion gear. Furthermore, the ring gear may have a shape that is rotationally symmetrical with respect to the third rotation axis A3. For example, the ring gear may have a shape, of which a width of an upper end in the horizontal direction is smaller than a width of a lower end in the horizontal direction. As a detailed example, the ring gear may have a shape, of which a width in the horizontal direction increases as it goes from the upper end to the lower end. As a more detailed example, when one side of the ring gear in the horizontal direction is viewed in parallel to the horizontal direction, the ring gear may have an equilateral trapezoidal shape.

The pinion gear may be connected to one end of the third shaft 123-1′″ in the direction of the eccentric assistant rotation axis Ae. The pinion gear may have a shape that is rotationally symmetrical with respect to the eccentric assistant rotation axis Ae. For example, the pinion gear may have a shape, in which a width in the upward/downward direction of an end of a first pinion, which is an end on one side in the direction of the eccentric assistant rotation axis Ae, is smaller than a width in the upward/downward direction of an end of a second pinion, which is an end in an opposite side in the direction of the eccentric assistant rotation axis Ae. As a detailed example, the pinion gear may have a shape, of which a width in the upward/downward direction increases as it goes from the first pinion end to the second pinion end. As a more detailed example, when one side of the pinion gear in the horizontal direction is viewed in parallel to the horizontal direction, the pinion gear may have an equilateral trapezoidal shape.

The driving force generated by the third motor 123′″ may be sequentially transmitted to the third shaft 123-1′″, the pinion gear, the ring gear, and the steering area 124-2″.

### Fifth Embodiment

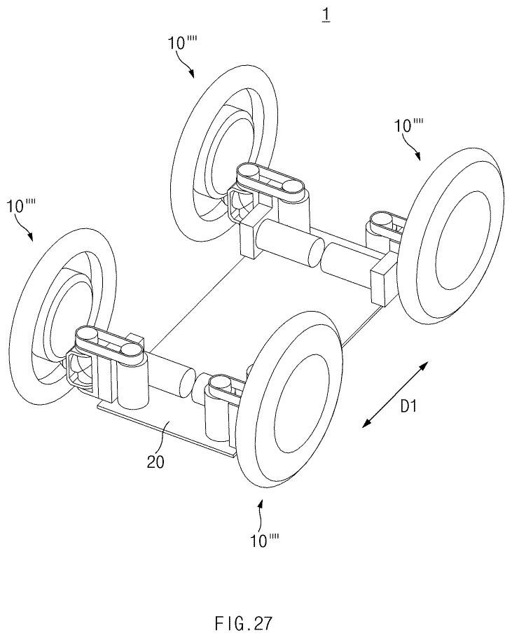

Hereinafter, a wheel assembly 10″″ according to the fifth embodiment of the present disclosure is described with reference to FIGS. 27 to 32. In a description of the wheel assembly 10″″ according to the fifth embodiment of the present disclosure, differences from the third embodiment of the present disclosure are mainly described.

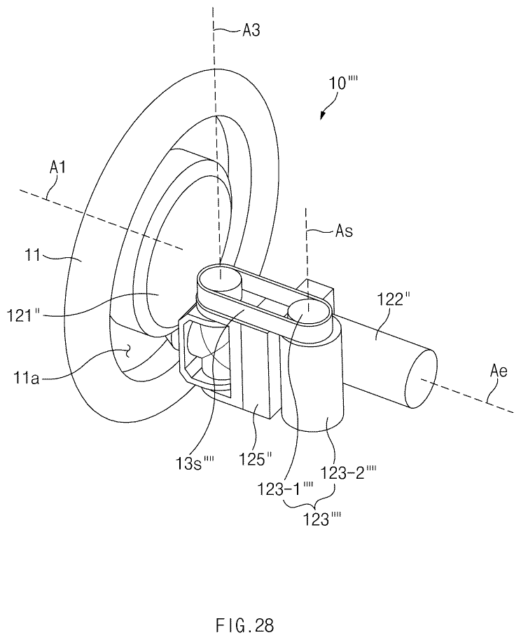

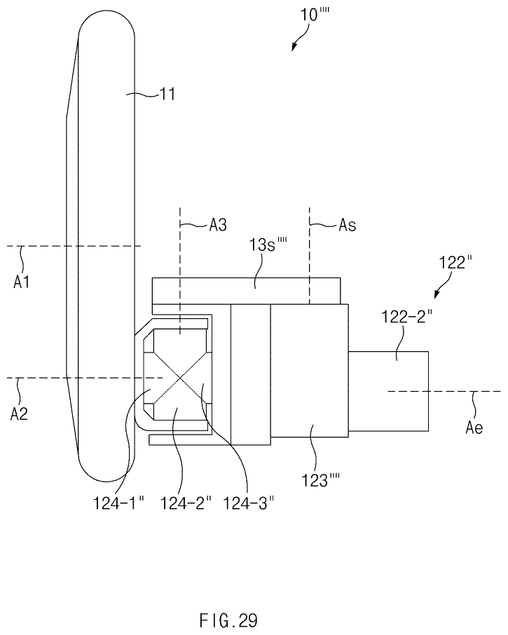

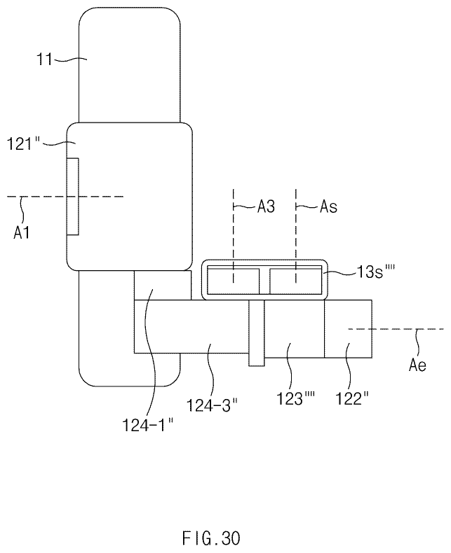

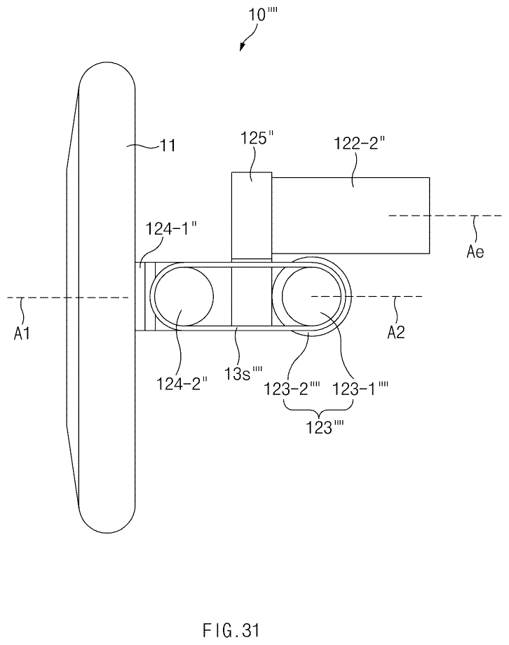

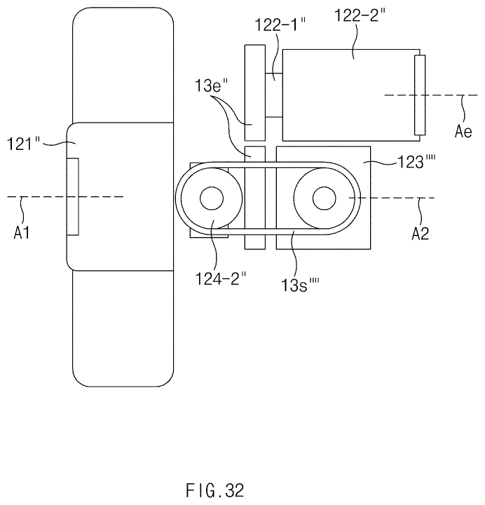

FIG. 27 is a perspective view of a vehicle according to the fifth embodiment of the present disclosure, and FIG. 28 is a perspective view of a wheel assembly according to the fifth embodiment of the present disclosure. FIG. 29 is a front view of the wheel assembly according to the fifth embodiment of the present disclosure, and FIG. 30 is a front view schematically illustrating the wheel assembly according to the fifth embodiment of the present disclosure. FIG. 31 is a plan view of the wheel assembly according to the fifth embodiment of the present disclosure, and FIG. 32 is a plan view schematically illustrating the wheel assembly according to the fifth embodiment of the present disclosure.

Referring to FIGS. 27 and 28, a wheel assembly 10″″ according to the fifth embodiment of the present disclosure includes a wheel 11, driving modules 121″, 122″, 123″″, 124″, and 125″, an eccentric power transmitting part 13e″, and a steering power transmitting part 13s″″. For a description of the wheel 11 according to the fifth embodiment, the description of the wheel 11 according to the third embodiment is used.

In addition, the driving modules 121″, 122″, 123″″, 124″, and 125″ according to the fifth embodiment include a first motor 121″ and a second motor 122″, a third motor 123″″, a connection area 124″, and a driving body 125″. The first motor 121″ may include a first shaft and a first driving part. The first driving part may include a first stator, a first rotor, and a first housing. For a description of the first shaft, the first stator, the first rotor, and the first housing according to the fifth embodiment, the description of the first shaft, the first stator, the first rotor, and the first housing according to the third embodiment is used.

The second motor 122″ may include a second shaft 122-1″ and a second driving part 122-2″. The second driving part 122-2″ may include a second stator, a second rotor, and a second housing. For a description of the second shaft 122-1″, the second stator, the second rotor, and the second housing according to the fifth embodiment, the description of the second shaft 122-1″, the second stator, the second rotor, and the second housing according to the third embodiment is used.

Referring further to FIGS. 29 to 32, the third motor 123″″ may provide a driving force to the wheel 11 to steer the wheel 11. The third motor 123″″ may control a traveling direction of the wheel 11 with respect to the body 20. For example, the third motor 123″″ may revolve the wheel 11 with respect to the body 20 about the third rotation axis A3. The third rotation axis A3 may be defined as an imaginary straight line that extends in a direction that crosses the first rotation axis A1 and the second rotation axis A2. As an example, the third rotation axis A3 may be perpendicular to the first rotation axis A1 and the second rotation axis A2. As an example, the third rotation axis A3 may be defined as an imaginary straight line that extends in the upward/downward direction that is perpendicular to the ground.

A relative position of the second rotation axis A2 to the third rotation axis A3 may be fixed. In other words, regardless of the movement of the wheel 11, the relative positions of the second rotation axis A2 and the third rotation axis A3 to the body 20 may be fixed. Furthermore, the first rotation axis A1 may be configured to be revolved about the third rotation axis A3.

Furthermore, as an example, the third rotation axis A3 may cross the second rotation axis A2 at one point. As an example, a crossing point, at which the third rotation axis A3 and the second rotation axis A2 cross each other may be located at the connection area 124″.

The third motor 123″″ may be disposed to be spaced apart from the third rotation axis A3 in the direction of the second rotation axis A2.

For example, referring back to FIGS. 27 and 28, the third motor 123″″ of the wheel assembly 10, which is disposed on a front left side of the body 20, may be disposed to be spaced rightward apart from the third rotation axis A3. Furthermore, the third motor 123 of the wheel assembly 10, which disposed on a front right side of the body 20, may be disposed to be spaced leftward apart from the third rotation axis A3.

Furthermore, the third motor 123″″ of the wheel assembly 10, which is disposed on a rear left side of the body 20, may be disposed to be spaced rightward apart from the third rotation axis A3. Furthermore, the third motor 123″″ of the wheel assembly 10, which is disposed on a rear right side of the body 20, may be disposed to be spaced leftward apart from the third rotation axis A3.

Referring back to FIG. 29, an upper end of the third motor 123″″ may be disposed on an upper side of the second motor 122″. In other words, a height of the upper end of the second motor 122″ may be formed to be smaller than a height of an upper end of the third motor 123″″. For example, a spacing distance between the upper end of the third motor 123″″ and a lower end of the second motor 122″ may be smaller than a radius of the wheel 11.

The third motor 123″″ and the steering area 124-2″ may be disposed to be spaced apart from each other along the direction of the second rotation axis A2 with the driving body 125″ being interposed therebetween. In addition, when one side of the wheel assembly 10″″ in the direction of the second rotation axis A2 is viewed in a direction that is parallel to the second rotation axis A2, the third motor 123″″ and the steering area 124-2″ may overlap each other. Furthermore, when one side of the wheel assembly 10″″, in the direction of the second rotation axis A2, is viewed in a direction that is parallel to the second rotation axis A2, the third rotation axis A3 and the steering assistant rotation axis As may overlap each other. The third motor 123″″ may include a third shaft 123-1″″ and a third driving part 123-2″″.

The third shaft 123-1″″ may be an axial member that defines a steering assistant rotation axis As. The third shaft 123-1″″ may be named ‘a steering assistant shaft’. The steering assistant rotation axis As may be defined as an imaginary straight line that extends in a direction that is parallel to the third rotation axis A3, and is spaced apart from the third rotation axis A3 in the direction of the second rotation axis A2.

The third driving part 123-2″″ may rotate the third shaft 123-1″″ about the steering assistant rotation axis As. The third driving part 123-2″″ may be named ‘a steering driving part’. The third driving part 123-2″″ may include a third stator, a third rotor, and a third housing.

A relative position of the third stator to the third housing may be fixed. Furthermore, a third shaft 123-1″″ may be fixed to the third rotor. The third rotor may be rotated about the steering assistant rotation axis As together with the third shaft 123-1″″ with respect to the third stator.

The third housing may define an exterior of the third motor 123″″ together with the third shaft 123-1″″. The third stator and the third rotor may be accommodated in an interior of the third housing. As an example, the third housing may have a cylindrical shape. The third housing may be oriented in parallel to the steering assistant rotation axis As.

For example, when one side of the third motor 123″″ in the direction of the steering assistant rotation axis As is viewed in a direction that is parallel to the steering assistant rotation axis As, the third motor 123″″ may be oriented such that the third shaft 123-1″″ is located in the third driving part 123-2″″(e.g., the third housing).

Referring to FIGS. 31 and 32, when one side of the wheel assembly 10″″ in the first direction D1 is viewed in a direction that is parallel to the first direction D1, at least a portion (e.g., a portion of the second housing) of the second motor 122″ and at least a portion (e.g., a part of the third housing that is described below) of the third motor 123″″ overlap each other. For example, when one side of the wheel assembly 10″″ in the first direction D1 is viewed in a direction that is parallel to the first direction D1, the steering assistant rotation axis As may be located in the second housing with respect to the second rotation axis A2. In addition, when one side of the wheel assembly 10″″ in the first direction D1 is viewed in a direction that is parallel to the first direction D1, the second rotation axis A2 may be located between an upper end and a lower end of the third housing.

The connection area 124″ according to the fifth embodiment may include a revolution area 124-1″, a steering area 124-2″, and an eccentric area 124-3″. For a description of the revolution area 124-1″, the steering area 124-2″, and the eccentric area 124-3″ according to the fifth embodiment, the description of the revolution area 124-1″, the steering area 124-2″, and the eccentric area 124-3″ according to the third embodiment is used.

For a description of the driving body 125″ according to the fifth embodiment, the description of the driving body 125″ according to the third embodiment is applied.

For a description of the eccentric power transmitting part 13e″ according to the fifth embodiment, the description of the eccentric power transmitting part 13e″ according to the third embodiment is applied.

The steering power transmitting part 13s″″ may connect the steering area 124-2″ and the third shaft 123-1″″. The steering power transmitting part 13s″″ may be connected to an upper end of the steering area 124-2″ and an upper end of the third shaft 123-1″″.

The steering power transmitting part 13s″″ may receive a driving force from the third shaft 123-1″″, and may transmit the received driving force to the steering area 124-2″. A cross-section of the steering power transmitting part 13s″″ may have a shape of a closed curve shape that surrounds the steering area 124-2″″ and the third shaft 123-1″″. The horizontal direction may mean a direction that is perpendicular to the upward/downward direction.

For example, each of the steering area 124-2″ and the third shaft 123-1″″ may have a shape of a sprocket, and the steering power transmitting part 13s″″ may have a shape of a chain that is engaged with the steering area 124-2″ and the third shaft 123-1″″.

As another example, the steering power transmitting part 13s″″ may be provided as a belt that is attached to the steering area 124-2″ and the third shaft 123-1″″. As a detailed example, the steering power transmitting part 13s″″ may be formed of a rubber material. As a more detailed example, due to the frictional force generated between the steering power transmitting part 13s″″ and the steering area 124-2″, and the frictional force between the steering power transmitting part 13s″″ and the third shaft 123-1′″, a rotational force of the third shaft 123-1″″ may be sequentially transmitted to the steering power transmitting part 13s″″ and the steering area 124-2″″, and thus, the steering area 124-2″″ may be rotated about the third rotation axis A3.

### Sixth Embodiment

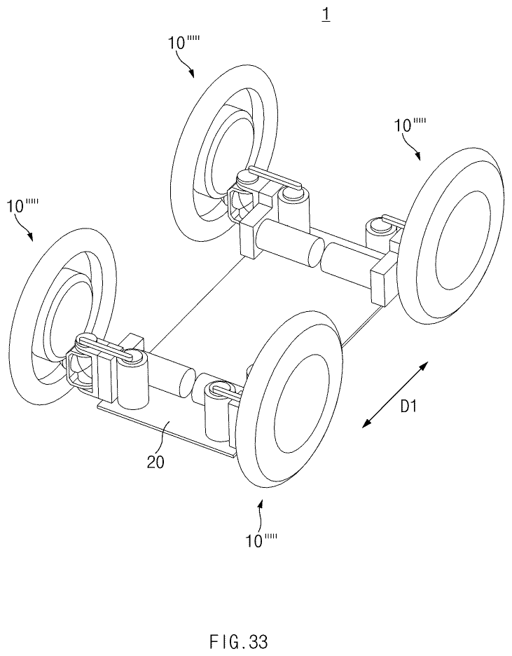

Hereinafter, a wheel assembly 10″′″ according to the sixth embodiment of the present disclosure is described with reference to FIGS. 33 to 38. In a description of the wheel assembly 10″′″ according to the sixth embodiment of the present disclosure, differences from the fifth embodiment of the present disclosure are mainly described.

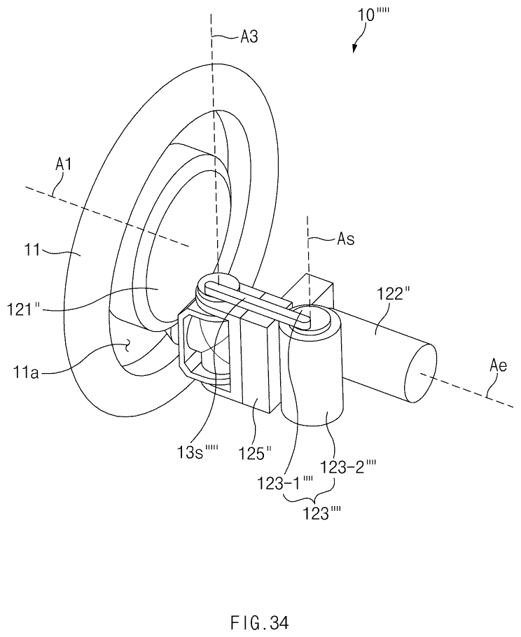

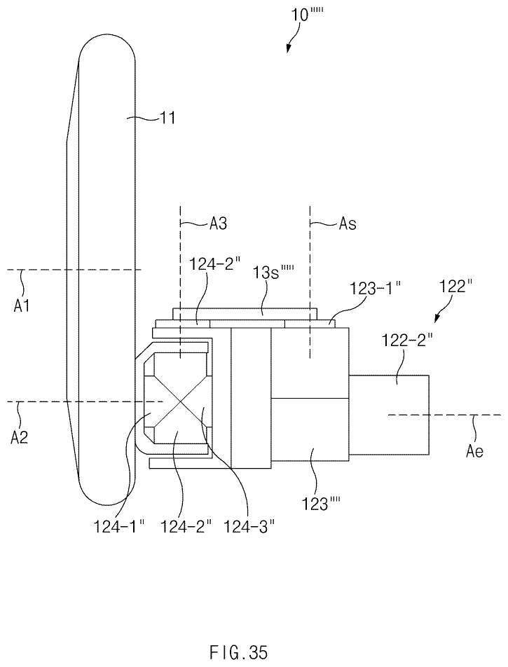

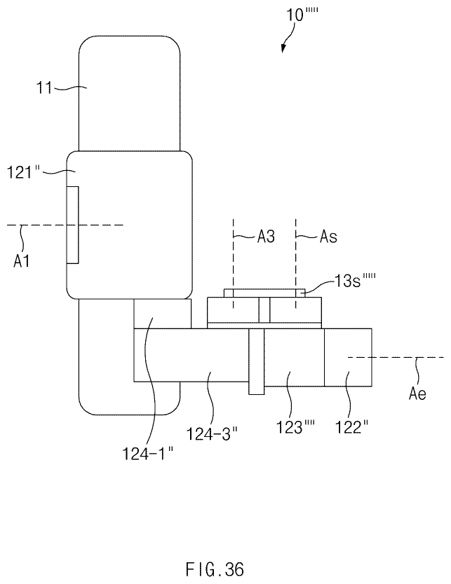

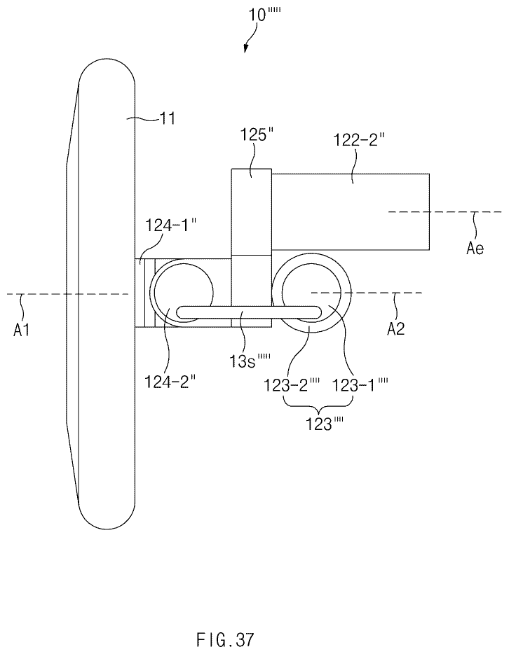

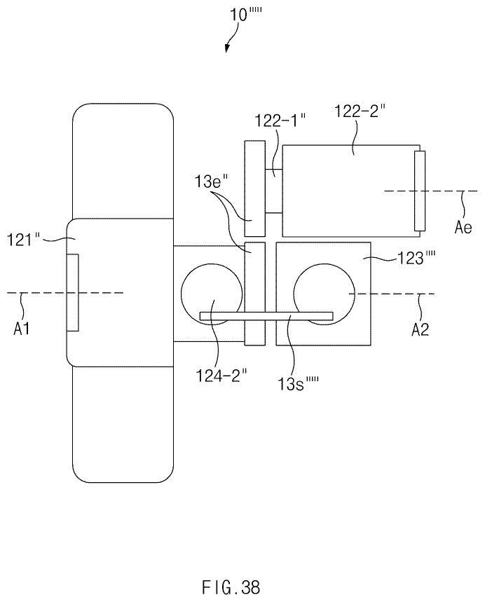

FIG. 33 is a perspective view of a vehicle according to a sixth embodiment of the present disclosure, and FIG. 34 is a perspective view of a wheel assembly according to the sixth embodiment of the present disclosure. Furthermore, FIG. 35 is a front view of the wheel assembly according to the sixth embodiment of the present disclosure, and FIG. 36 is a front view schematically illustrating the wheel assembly according to the sixth embodiment of the present disclosure. FIG. 37 is a plan view of the wheel assembly according to the sixth embodiment of the present disclosure, and FIG. 38 is a plan view schematically illustrating the wheel assembly according to the sixth embodiment of the present disclosure.

Referring to FIGS. 33 and 34, the wheel assembly 10″″ according to the sixth embodiment may include a wheel 11, driving modules 121″, 122″, 123″″, 124″, and 125″, an eccentric power transmitting part 13e″, and a steering power transmitting part 13s″′″. For a description of the wheel 11 according to the sixth embodiment, the description of the wheel 11 according to the fifth embodiment is used.

In addition, the driving modules 121″, 122″, 123″″, 124″, and 125″ according to the sixth embodiment include a first motor 121″, a second motor 122″, a third motor 123″″, a connection area 124″, and a driving body 125″. The first motor 121″ may include a first shaft and a first driving part. The first driving part may include a first stator, a first rotor, and a first housing. For a description of the first shaft, the first stator, the first rotor, and the first housing according to the sixth embodiment, the description of the first shaft, the first stator, the first rotor, and the first housing according to the fifth embodiment is applied.

The second motor 122″ may include a second shaft 122-1″ and a second driving part 122-2″. The second driving part 122-2″ may include a second stator, a second rotor, and a second housing. For a description of the second shaft 122-1″, the second stator, the second rotor, and the second housing according to the sixth embodiment, the description of the second shaft 122-1″, the second stator, the second rotor, and the second housing according to the fifth embodiment is used.

The third motor 123″″ may include a third shaft 123-1″″ and a third driving part 123-2″″. The third driving part 123-2″″ may include a third stator, a third rotor, and a third housing. For a description of the third shaft 123-1″″, the second stator, the second rotor, and the second housing according to the sixth embodiment, the description of the third shaft 123-1″, the second stator, the second rotor, and the second housing according to the fifth embodiment is used.

The connection area 124″ according to the sixth embodiment may include a revolution area 124-1″, a steering area 124-2″, and an eccentric area 124-3″. For a description of the revolution area 124-1″, the steering area 124-2″, and the eccentric area 124-3″ according to the sixth embodiment, the description of the revolution area 124-3″, the steering area 124-2″, and the eccentric area 124-3″ according to the fifth embodiment is used.

For a description of the driving body 125″ according to the sixth embodiment, the description of the driving body 125″ according to the fifth embodiment is used.

For a description of the eccentric power transmitting part 13e″ according to the sixth embodiment, the description of the eccentric power transmitting part 13e″ according to the fifth embodiment is used.

Referring to FIGS. 35 to 38, the steering power transmitting part 13s″′″ may include a first end, a second end, and a link. The first end may define one end of the steering power transmitting part 13s″′″. The first end may be connected to the upper end of the steering area 124-2″. Furthermore, the first end may be spaced apart from the third rotation axis A3 in the horizontal direction.

For example, the first end may be connected to the upper end of the steering area 124-2″ to be rotated about the first link rotation axis. The first link rotation axis may be defined as an imaginary straight line that passes through the first end and is parallel to the third rotation axis A3. The first end may be configured to be revolved about the third rotation axis A3 when the steering area 124-2″ is rotated about the third rotation axis A3.

The second end may define an opposite end of the steering power transmitting part 13s″′″. The second end may be connected to an upper end of the third shaft 123-1″″. The second end may be spaced apart from the steering assistant rotation axis As in the horizontal direction.

For example, referring to FIGS. 37 and 38, the second end may be connected to the upper end of the third shaft 123-1″″ to be rotated about the second link rotation axis. The second link rotation axis may be defined as an imaginary straight line that passes through the second end and is parallel to the steering assistant rotation axis As. The second end may be revolved about the steering assistant rotation axis As when the third shaft 123-1″″ is rotated about the steering assistant rotation axis As.

The link may connect the first end and the second end. The link may be integrally formed with the first end and the second end. The link may be oriented in parallel to a direction, in which the third rotation axis A3 and the steering assistance axis face each other. For example, when the first end and the second end are revolved about the steering area 124-2″ and the third shaft 123-1″″, respectively, a direction, in which the link is oriented, may be maintained constant.

Through the orientation structure of the link, rotation angles of the third shaft 123-1″″ and the steering area 124-2″ may be formed to be the same when a driving force of the third shaft 123-1″″ is transmitted to the steering area 124-2″.

The wheel assembly according to the present disclosure has various degrees of freedom as compared with the conventional technology and thus has a new structure that may cope with changes in external factors, such as ground environments.

In the above description, just because all the components constituting the embodiment of the present disclosure are described as being combined or operating in combination, the present disclosure is not necessarily limited to this embodiment. That is, within the scope of the purpose of the present disclosure, all of the components may operate in selective combination of one or more. In addition, terms such as “include,” “comprise,” or “have” described above mean that the corresponding component may be present, and thus do not exclude other components unless specifically stated to the contrary, and rather, it should be interpreted as being able to include other components. Unless defined differently, all the terms including technical or scientific terms have the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

The above description is a simple exemplary description of the technical spirits of the present disclosure, and an ordinary person in the art, to which the present disclosure pertains, may make various corrections and modifications without departing from the essential characteristics of the present disclosure. Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A wheel assembly comprising:
a wheel; and
a driving module connected to the wheel,
wherein the driving module includes:
a first motor defining a first rotation axis extending in an axial direction of the wheel, and configured to rotate the wheel about the first rotation axis;
a second motor configured to rotate the wheel about a second rotation axis spaced apart from the first rotation axis in a radial direction of the wheel; and
a third motor configured to provide a driving force for steering the wheel in a third rotation axis, which extends in a direction that crosses both the first rotation axis and the second rotation axis, and
wherein the second motor is disposed to be spaced apart from the third rotation axis in a first direction, wherein the first direction crosses both the second rotation axis and the third rotation axis.

2. The wheel assembly of claim 1, wherein the first rotation axis passes through a center of the wheel, and
wherein the first motor is configured to rotate the wheel about the first rotation axis.

3. The wheel assembly of claim 1, wherein the second motor is disposed to be spaced apart from the second rotation axis in the first direction and the second motor is configured to revolve the wheel about the second rotation axis.

4. The wheel assembly of claim 1, wherein the first rotation axis is configured to be revolved about the third rotation axis, and
wherein the second rotation axis is configured such that a relative position thereof to the third rotation axis is fixed.

5. The wheel assembly of claim 1, wherein the third rotation axis extends in parallel to an upward/downward direction, and
wherein the second motor is disposed on a lower side of an upper end of the third motor.

6. The wheel assembly of claim 1, wherein the first direction is perpendicular to the second rotation axis and the third rotation axis, and
when one side of the wheel assembly, in a direction of the third rotation axis, is viewed in a direction being parallel to the third rotation axis, the third rotation axis and a shaft provided in the third motor cross each other.

7. The wheel assembly of claim 1, wherein the driving module further includes:
a connection area connecting the wheel and the second motor, and
wherein the connection area includes:
a revolution area configured to be revolved about the first rotation axis along a circumferential direction of the wheel;
a steering area defining the third rotation axis and configured to rotate the revolution area about the third rotation axis; and
an eccentric area defining the second rotation axis and connecting the steering area and the second motor.

8. The wheel assembly of claim 7, wherein the driving module further includes:
an eccentric power transmitting part configured to transmit a driving force of the second motor to the eccentric area,
wherein the second motor includes:
an eccentric assistant shaft being parallel to the second rotation axis, and defining an eccentric assistant rotation axis passing through the second motor, and
wherein the eccentric power transmitting part is configured to connect the eccentric area and the eccentric assistant shaft.

9. The wheel assembly of claim 8, wherein the eccentric power transmitting part includes:
a first gear connected to the eccentric area; and
a second gear connected to the eccentric assistant shaft, and
wherein the first gear and the second gear are engaged with each other.

10. The wheel assembly of claim 8, wherein a cross-section of the eccentric power transmitting part taken along the first direction has a shape of a closed curve surrounding the eccentric area and the eccentric assistant shaft.

11. The wheel assembly of claim 10, wherein each of the eccentric area and the eccentric assistant shaft has a shape of a sprocket, and
wherein the eccentric power transmitting part has a shape of a chain engaged with the eccentric area and the eccentric assistant shaft.

12. The wheel assembly of claim 10, wherein the eccentric power transmitting part is provided as a belt, attached to the eccentric area and the eccentric assistant shaft, and formed of a rubber material.

13. The wheel assembly of claim 7, wherein the third motor includes:
a steering shaft defining the third rotation axis; and
a steering driving part configured to rotate the steering shaft about the third rotation axis, and
wherein when one side of the third motor, in a direction of the third rotation axis, is viewed in a direction being parallel to the third rotation axis, the steering shaft is located inside the steering driving part.

14. The wheel assembly of claim 7, wherein the driving module further includes:
a steering power transmitting part configured to transmit a driving force of the third motor to the steering area,
wherein the third motor includes:
a steering assistant shaft crossing the third rotation axis, and defining a steering assistant rotation axis passing through the third motor,
wherein the steering power transmitting part is provided as a bevel gear, and
wherein the steering power transmitting part includes:
a ring gear connected to the steering area; and
a pinion gear connected to the steering assistant shaft and configured to engage with the ring gear.

15. The wheel assembly of claim 7, wherein the driving module further includes:
a steering power transmitting part configured to transmit a driving force of the third motor to the steering area,
wherein the third motor includes:
a steering assistant shaft being parallel to the third rotation axis, and defining a steering assistant rotation axis passing through the third motor, and
wherein the steering power transmitting part connects the steering area and the steering assistant shaft.

16. The wheel assembly of claim 15, wherein the steering power transmitting part is connected to an upper end of the steering area and an upper end of the steering assistant shaft.

17. The wheel assembly of claim 15, wherein a cross-section of the steering power transmitting part in a horizontal direction has a shape of a closed curve surrounding the steering area and the steering assistant shaft.

18. The wheel assembly of claim 17, wherein each of the steering area and the steering assistant shaft has a shape of a sprocket, and
wherein the steering power transmitting part has a shape of a chain engaged with the steering area and the steering assistant shaft.

19. The wheel assembly of claim 17, wherein the steering power transmitting part is provided as a belt, attached to the steering area and the steering assistant shaft, and formed of a rubber material.

20. The wheel assembly of claim 15, wherein the third rotation axis extends in parallel to an upward/downward direction,
wherein the steering power transmitting part includes:
a first end connected to the steering area to be spaced apart from the third rotation axis in a horizontal direction that is perpendicular to the third rotation axis;
a second end connected to the steering assistant shaft to be spaced apart from the steering assistant rotation axis in the horizontal direction; and
a link connecting the first end and the second end, and
wherein the link is oriented in parallel to a direction, in which the third rotation axis and the steering assistant rotation axis face each other.

21. The wheel assembly of claim 1, wherein the second motor includes:
an eccentric assistant shaft being parallel to the second rotation axis, and defining an eccentric assistant rotation axis passing through the second motor; and
an eccentric driving part configured to rotate the eccentric assistant shaft, and
wherein when one side of the second motor, in a direction of the second rotation axis, is viewed in a direction being parallel to the second rotation axis, the eccentric assistant shaft is located inside the eccentric driving part.

22. The wheel assembly of claim 1, wherein the first motor is disposed in an interior of the wheel such that a center thereof crosses the first rotation axis.

23. The wheel assembly of claim 1, wherein the first motor includes:
a wheel driving part configured to provide a driving force for rotating the wheel about the first rotation axis;
a driving shaft being parallel to the first rotation axis, defining a wheel driving rotation axis spaced apart from the first rotation axis in a radial direction of the wheel, and provided in the wheel driving part to be rotatable; and
a wheel power transmitting part connecting the driving shaft and a central portion of the wheel, through which the first rotation axis passes, and configured to transmit a rotational force of the driving shaft to the wheel, and
wherein a cross-section of the wheel power transmitting part in a radial direction of the wheel has a shape of a closed curve surrounding the central portion of the wheel.

24. The wheel assembly of claim 23, wherein each of the central portion of the wheel and the driving shaft has a shape of a sprocket, and
wherein the wheel power transmitting part has a shape of a chain engaged with the central portion of the wheel and the driving shaft.

25. The wheel assembly of claim 23, wherein the wheel power transmitting part is provided as a belt attached to the central portion of the wheel and the driving shaft and formed of a rubber material.

26. A vehicle comprising:
a body; and
a wheel assembly configured to cause the body to move, and adjust a height of the body with respect to a ground,
wherein the wheel assembly includes:
a wheel; and
a driving module connected to the wheel,
wherein the driving module includes:
a first motor defining a first rotation axis extending in an axial direction of the wheel, and configured to rotate the wheel about the first rotation axis;
a second motor configured to rotate the wheel about a second rotation axis spaced apart from the first rotation axis in a radial direction of the wheel; and
a third motor configured to provide a driving force for steering the wheel in a third rotation axis extending in a direction that crosses the first rotation axis and the second rotation axis, and
wherein the second motor is disposed to be spaced apart from the third rotation axis in a first direction that crosses the second rotation axis and the third rotation axis.
